(19) United States
(12) Patent Application Publication
(10) Pub. No.: US 2013/0205385 A1
(43) Pub. Date: Aug. 8, 2013

(54) PROVIDING INTENT-BASED ACCESS TO USER-OWNED RESOURCES

(71) Applicants: Franziska Roesner, Seattle, WA (US); Tadayoshi Kohno, Seattle, WA (US); Alexander Moshchuk, Kirkland, WA (US); Bryan J. Parno, Seattle, WA (US); Helen J. Wang, Redmond, WA (US)

(72) Inventors: Franziska Roesner, Seattle, WA (US); Tadayoshi Kohno, Seattle, WA (US); Alexander Moshchuk, Kirkland, WA (US); Bryan J. Parno, Seattle, WA (US); Helen J. Wang, Redmond, WA (US)

(73) Assignee: Microsoft Corporation, Redmond, WA (US)

(21) Appl. No.: 13/368,334

(22) Filed: Feb. 8, 2012

(51) Int. Cl. G06F 21/00

(52) U.S. Cl. 726/17

(57) ABSTRACT

An access system is described herein which allows an application to access a system-level and/or application-specific user-owned resource based on a user's interaction with an intent-based access mechanism. For example, the intent-based access mechanism may correspond to a gadget that is embedded in an application user interface provided by the application, and/or logic for detecting a permission-granting input sequence. The access system accommodates different types of intent-based access mechanisms. One type is a scheduled intent-based access mechanism. Another type provides access to two or more user-owned resources. Further, the access system includes a mechanism for determining whether the application is permitted to use an intent-based access mechanism.

### BACKGROUND

Different strategies exist for enabling an application to interact with a user-owned resource. As used herein, a user-owned resource refers to any functionality, control setting, or data associated with a user who interacts with a user device. For example, one type of user-owned resource may correspond to a camera resource that is provided by the user device.

On one extreme of the design spectrum, an access strategy may treat all user-owned resources as global resources. This permits any application that is installed on the user device to access any user-owned resource without restriction. A traditional desktop environment that runs on a personal computer uses this type of an access strategy. That is, an application that runs using the desktop system can generally access any of the resources provided by the personal computer by virtue of the fact that the user has permitted the application to be installed on the personal computer. On the opposite extreme of the design spectrum, an access strategy may treat each application as an isolated principal that has no access to any user-owned resource under any circumstance. Some types of traditional browser systems use this type of an access strategy or a variation of this type of access strategy. For instance, a web application that runs using this type of browsing system is generally not allowed to access the user-owned resources installed on the computer device which runs the browsing system.

The first-mentioned access strategy is not optimal because an application may represent a malicious entity which can access and utilize the user's resources in undesirable ways. The second access strategy is not optimal because an application may have a legitimate need to access a user-owned resource. Preventing the application from accessing a resource in this circumstance therefore reduces the utility of the application, or may force the application to rely on less efficient work-around solutions to access the user-owned resource. For example, a browser system may rely on a browser add-on to interact with a user-owned resource. But many browser add-ons enjoy overly broad access rights with respect to certain user-owned resources, and thereby may subject the user to undue security risks.

To address the above shortcomings, the industry has proposed various intermediate access strategies, e.g., for use on smartphones. In one case, an access strategy may treat the applications as isolated entities. When an application requires access to a user-owned resource, a system which runs the application can display a prompt to the user, asking the user whether to grant the application permission to access the user-owned resource. This strategy is not optimal, however, because the user may perceive the prompts as bothersome. In addition, the user may simply answer such prompts in the affirmative in rote fashion, e.g., without fully considering the rights being conferred. In another case, an access strategy involves providing a manifest which describes the access rights conferred to an application. Upon installing an application, the access strategy may ask the user to accept or decline the permission rights described in the manifest. This access strategy, however, is also not optimal because a user may not readily understand the nature of the rights described in the manifest. Further, the manifest may grant the application overly broad access rights.

The above-noted potential shortcomings are set forth by way of illustration, not limitation. Known access strategies may suffer from additional potential drawbacks.

### SUMMARY

An access system is described herein which allows an application to access a user-owned resource based on a user's interaction with an intent-based access mechanism (IBAM). That is, the access system interprets this interaction as conveying the user's implicit and authentic intent that the application be allowed to access the user-owned resource. The IBAM may be implemented, in part, using a resource monitor which mediates access to the user-owned resource.

According to one implementation, the IBAM corresponds to a gadget that is embedded in an application user interface provided by the application. In another case, the IBAM corresponds to logic for detecting a permission-granting (PG) input sequence that a user may use while interacting with the application.

According to one illustrative feature, the access system accommodates different types of IBAMs and corresponding resource monitors, such as a single-transaction access IBAM, a session-based access IBAM, a permanent access IBAM, a scheduled IBAM (which permits access based on at least one scheduling condition), etc.

According to another illustrative feature, the access system includes a composite IBAM and an associated composite resource monitor that mediates access to two or more user-owned resources.

According to another illustrative feature, the IBAM and its associated resource monitor may represent system-level functionality which mediates access to at least one system-level resource, such as a camera, a printer, a location device, message-sending functionality, a clipboard store, etc. In another case, the IBAM and its associated resource monitor may represent application-specific functionality which mediates access to at least one application-specific resource via an interface provided by a hosting application.

A content-view gadget represents an example of an application-specific IBAM. A first hosting application may expose the content-view gadget to ensure authentic interaction with its application-maintained data, via its exposed application programming interface (API). A second application may embed the content-view gadget in its application user interface to convey the user's authentic intent to grant the second application permission to invoke the API of the first hosting application on the user's behalf.

According to another feature, the access system includes a mechanism for determining whether a specified application permits the IBAM to be embedded (in an active state) in the application user interface provided by the specified application. If the application user interface is nested in one or more ancestor application user interfaces, this determination involves examining the permissions granted by the associated ancestor applications.

According to one possible benefit, the access system allows applications to access user-owned resources in a contextual manner that is not unduly burdensome to users. At the same time, the access system confers access rights that are narrowly tailored (e.g., conforming to a least-privilege paradigm of resource access), thereby not compromising the security of user-owned resources and other functionality associated with the access system.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative access system which allows applications to selectively access user-owned resources using one or more types of intent-based access mechanisms (IBAMs).

FIG. 2 shows an illustrative application for use in the access system of FIG. 1.

FIG. 3 shows nested user application user interfaces (UIs) provided by respective applications. Any of these applications may utilize an IBAM, if deemed permitted by the chain of nested applications.

FIG. 4 shows an illustrative resource monitor for use in the access system of FIG. 1; in some implementations, the resource monitor plays a role in managing access to a particular user-owned resource.

FIG. 5 shows an illustrative operating system for use in the access system of FIG. 1; in some implementations, logic within the operating system also plays a role in managing access to user-owned resources.

FIG. 6 shows an implementation of the access system of FIG. 1 in which at least one resource monitor corresponds to an application-specific resource monitor which implements an application-specific IBAM.

FIG. 7 shows an implementation of the access system of FIG. 1 in which at least one resource monitor corresponds to a composite resource monitor which mediates access to two or more user-owned resources via two or more respective component resource monitors.

FIG. 8 shows a first implementation of the access system of FIG. 1, involving the use of only local computing functionality.

FIG. 9 shows a second implementation of the access system of FIG. 1, involving the use of remote computing functionality.

FIG. 10 shows an example of an application UI that includes three gadgets embedded therein, two of which provide single-transaction access to a user-owned resource, and one of which provides session-based access to a user-owned resource.

FIG. 11 shows an example of an application UI that includes a gadget that provides scheduled access to a user-owned resource.

FIG. 12 shows an example of an application UI that includes a gadget that provides permanent access to a user-owned resource.

FIG. 13 shows an example of an application UI that incorporates a composite gadget that mediates access to two user-owned resources.

FIG. 14 shows an example of an application UI that incorporates a form-filling gadget.

FIG. 15 shows an example of an application UI that incorporates a file-picking gadget and a search gadget.

FIG. 16 shows an example of an application UI that incorporates a content-selection gadget that may be invoked in response to any of the gadgets shown in FIG. 15. The content-selection gadget, in turn, may embed one or more content-view gadgets exposed by one or more corresponding content-providing entities.

FIG. 17 shows one method whereby the access system (of FIG. 1) can communicate the characteristics of an IBAM to an operating system.

FIG. 18 shows one method whereby the access system can embed a gadget in an application UI.

FIG. 19 shows one method by which the access system can authorize an application to access a camera for a single picture-taking transaction.

FIG. 20 shows one method by which the access system can authorize an application to send a single print job to a printer.

FIG. 21 shows one method by which the access system can authorize an application to access a location device for one or more transactions within an application session.

FIG. 22 shows one method by which the access system can authorize an application to access both a camera and a location device for a single transaction.

FIGS. 23 and 24 together show one method by which the access system can authorize an application to access a data item provided by a content-providing entity.

FIG. 25 is a flowchart that represents an overview of one method whereby the access system (of FIG. 1) can incorporate an IBAM into an application interaction experience.

FIG. 26 is a flowchart that represents an overview of one method whereby the access system can determine whether it is appropriate to embed an IBAM into an application UI.

FIG. 27 shows illustrative computing functionality that can be used to implement any aspect of the features shown in the foregoing drawings.

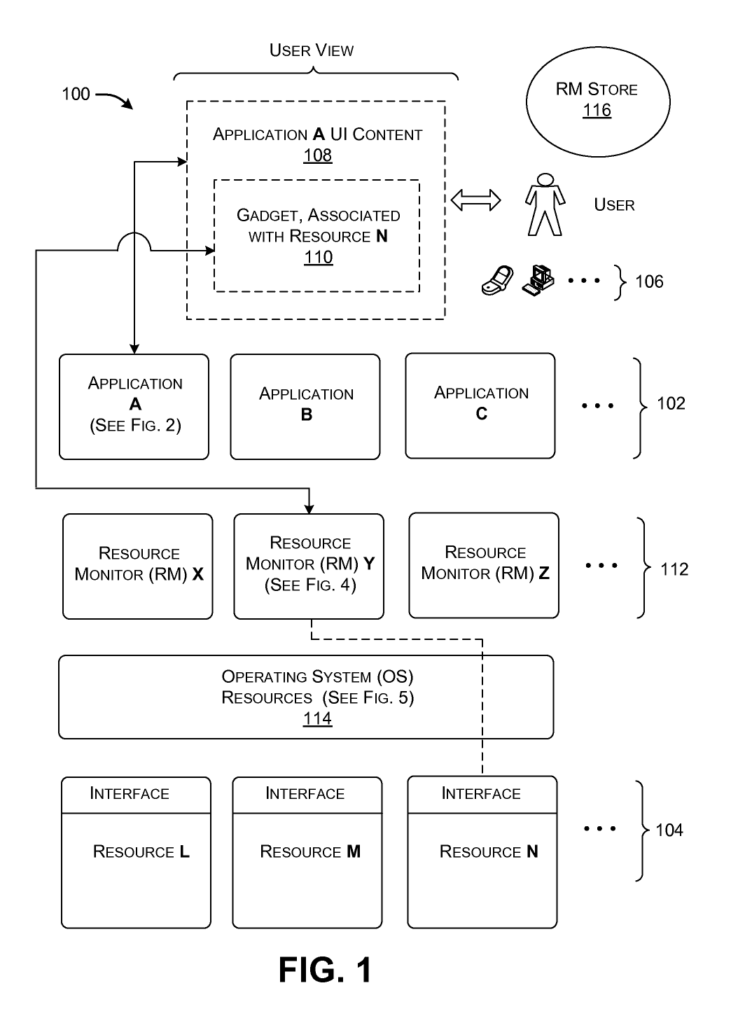

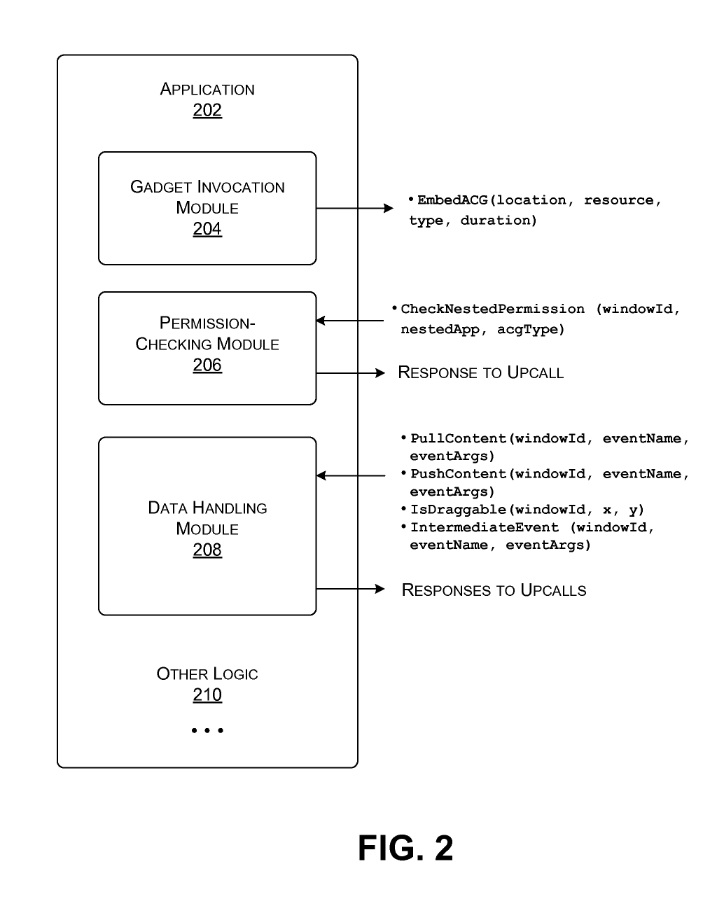

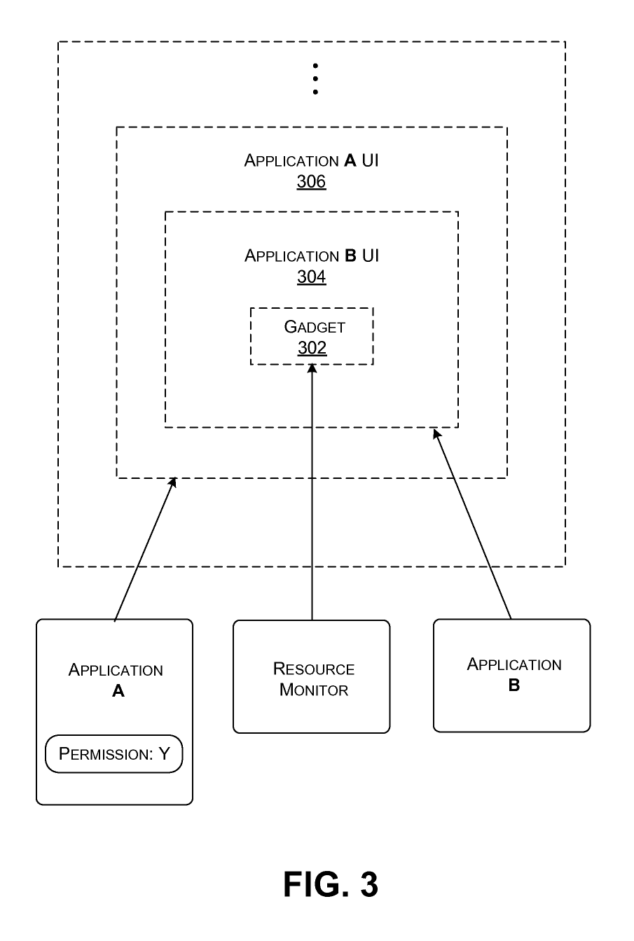

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative access system for allowing applications to access user-owned resources based on the user's interaction with intent-based access mechanisms. Section B describes illustrative methods which explain the operation of the access system of Section A. Section C describes illustrative computing functionality that can be used to implement any aspect of the features described in Sections A and B.

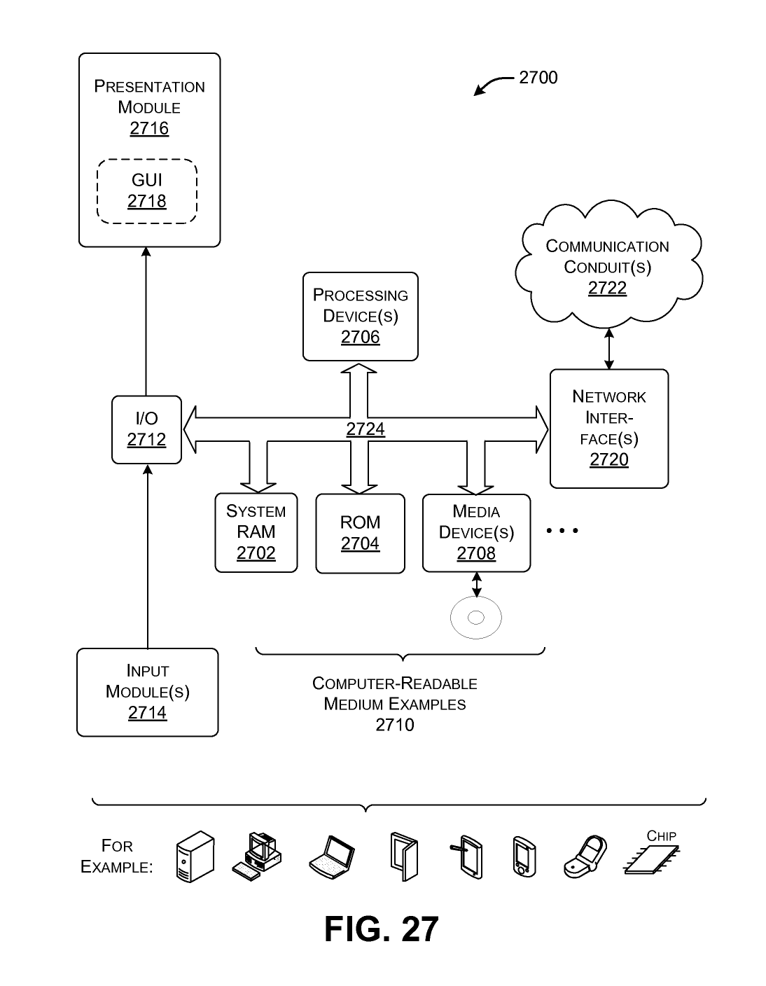

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 27, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations.

A. Illustrative Systems

A.1. Overview of the Access System

FIG. 1 shows an illustrative access system 100 that allows any number of applications 102 (e.g., applications A, B, C, etc.) to access any number of user-owned resources 104 (e.g., user-owned resources L, M, N, etc.). A user may interact with the applications 102, in turn, via any type of user device 106. In one case, the user device 106 may represent a traditionally stationary computing device, such as a personal computer, a game console system, a set-top box, etc. In another case, the user device 106 may represent a portable computing device, such as a smart phone, a personal digital assistant device, an ebook reader device, a handheld game-playing device, a tablet computing device, a laptop computing device, browser functionality (implemented using any computing device), and so on.

As used herein, an application refers to any type of functionality for performing any function. In some cases, an application can perform a high-level task. To name just a few possible high-level tasks, an application can perform a word-processing function, an image editing function, a social networking function, any business-related function, and so on. In another case, an application can perform a lower-level support task. To name just a few possible low-level tasks, an application can perform a file management task, a communication-related task, and so on.

An application can be implemented in any manner. For example, in one case, an application can represent a body of code that executes on any code runtime system. In another case, an application can represent a body of markup language content and/or script content that executes on a browser system, and so on. The functionality of an application can be implemented locally and/or remotely with respect to the user device 106.

A user-owned resource represents any functionality or information that is associated with a particular user and controlled by that user. Some user-owned resources may pertain to system-level resources associated with the user device 106 or other environment in which the applications 102 are executed. These system-level resources can be accessed by different applications, and therefore may be regarded as application-agnostic resources. Without limitation, for instance, system-level resources may encompass physical equipment, such as a camera, a location device (e.g., a GPS device), a motion-sensing device (e.g., an accelerometer), a printer, a microphone, a speaker, a message-transmission mechanism (e.g., an SMS-transmission mechanism), etc. The system-level resources can also encompass software-implemented functionality (e.g., virtual equipment), such as a clipboard store (for storing data in response to a copy or cut command), a transitory clipboard store (for storing data in response to the commencement of a drag operation), a contact list store, a user preference store, an autocomplete store (for storing data entered into a form), and so on. The system-level resources can also encompass control settings and device capabilities of any type that affect any component of the user device 106 (and/or the user device 106 as a whole, and/or any peripheral device associated with the user device 106). For example, a resource can correspond to a user-controlled ability to wipe or reboot the user device 106.

Other user-owned resources may pertain to application-specific resources. These are resources that are maintained by or otherwise associated with particular hosting applications. For example, the application-level resources may encompass data, services, etc. provided by an application. The data may correspond to any type of data, such as text data, control settings, image data, audio data, video data, markup language data, etc.

Any user-owned resource can be provided at a site that is local or remote with respect to the user device 106, or by a combination of sites. For example, a camera may represent a system-level resource that is a component of the user device 106. In another case, a user contact list may represent an application-specific resource that is provided by social networking application that is remotely located with respect to the user device 106. Another type of application-specific resource may correspond to a user's document repository maintained at a remote file storage site, and so on.

The above-described types of user-owned resources are mentioned by way of example, not limitation. Other environments can accommodate the inclusion of additional types of user-owned resources, and/or can omit one or more types of user-owned resources described above.

By way of overview, the access system 100 provides a security environment that is characterized by prescribed default behavior. In one implementation, for instance, the access system 100 isolates each principal from every other principal, such as by isolating each application from every other application. The access system 100 can achieve isolation in various ways, including, but not limited to, process-based isolation, language-based isolation, virtual machine-implemented isolation, and so on. The access system 100 can define distinct applications in any manner, such as by treating applications which originate from different sources as distinct applications.

Further, the access system 100 permits an application to access a user-owned resource on the basis of a least-privilege mode of access. This means that access system 100 permits an application to access only those resources that it needs to perform its services. Otherwise, by default, the access system 100 does not allow any application to access any of the user-owned resources described above. The access system 100 does, however, permit an application to access basic system resources, such as CPU resources, memory resources, communication resources, etc.

To achieve the above-described behavior, the access system 100 uses at least one type of intent-based access mechanism (IBAM). An IBAM receives an input action from the user which implicitly conveys the user's authentic intent to allow an application to access a particular user-owned resource (or a particular combination of user-owned resources). If the user performs such an action, the access system 100 will grant the application access to the user-owned resource based on knowledge that the IBAM has received authentic user input. The rights conferred by this action are narrowly tailored because they apply to only a particular user-owned resource (or combination of resources), rather than all user-owned resources. Further, in many cases, the rights have a limited duration (to be described below). Further, the rights apply in a limited context to the application with which the user is currently interacting.

By virtue of the above-summarized manner of granting privileges, the access system 100 can offer a user-friendly interaction experience to a user. This is because the access system 100 need not burden the user with special-purpose prompts and permission-based dialogs that are extraneous to the user's interaction with an application. At the same time, due to the manner in which it narrowly confers access rights, the access system 100 reduces the risk that malicious applications and other malicious entities may improperly gain access to sensitive user-owned resources.

Nevertheless, the access system 100 can also use prompts and dialogs (and the like) as supplemental security provisions. That is, while the access system 100 does not require the use of such security provisions, it does not preclude the use of them. For example, the access system 100 may opt to use prompts when the IBAM grants permanent (but revocable) access to a user-owned resource. This is because this type of access poses greater risk that a malicious application can gain improper access to a user-owned resource, compared to one-time or session-based access.

The access system 100 can gauge the user's access-related intent in at least two ways described below. In a first technique, the IBAM may correspond to a gadget that is embedded in an application user interface (UI). Here, the access system 100 determines the user's intent based on the manner in which the user interacts with the gadget while interacting with the application UI. In a second technique, the IBAM corresponds to logic for detecting a permission-granting (PG) input sequence. The PG input sequence corresponds to a telltale gesture that the user may perform while interacting with the application using one or more input devices. That is, the gesture can be composed of one or more triggering input events, applied at the same time or in series, produced by the user using one or more input devices. For instance, the PM input sequence can be expressed using one or more key actuations (e.g., by pressing Ctrl-P to print), a mouse gesture, a touch gesture, a voice command, a device-movement gesture, a static or dynamic hand or body gesture (which can be detected in image or video data), etc., or any combination thereof.

First consider the use of gadgets, also referred to herein as access control gadgets or ACGs. A gadget refers to a UI element. The access system 100 presents the gadget on a display mechanism of the user device, such as on a display monitor of a personal computer or the touch screen of a smart phone. More specifically, the access system 100 presents the gadget in the context of an application UI provided by an application. As such, a user perceives the gadget as forming an integral part of the application UI. The gadget itself has at least one user interface control mechanism that allows a user to interact with the gadget. The gadget also can have any size, shape, informational content, style, etc. For instance, a gadget may resemble a button, a panel, a menu, a slider mechanism, etc.

For example, consider the high-level depiction provided by FIG. 1. Here, the application A presents an application UI 108 devoted to whatever service it provides. The access system 100 also presents a gadget 110 within the application UI 108. A user therefore perceives the gadget 110 as forming a part of the application UI 108, that is, as if provided by the application A itself.

A user may interact with the gadget 110 to enable the application A to receive data from the user-owned resource N, or to provide data to the user-owned resource N, or to change the status of the user-owned resource N, etc. That is, the particular nature of the gadget 110 determines the type of access action that is invoked by the gadget 110. By default, however, the application A has no privileges to access any user-owned resource, including the user-owned resource N.

The access system 100 uses a resource monitor Y to provide the gadget 110. The resource monitor also plays a role in mediating access by the application A to the resource N (in a manner that will be described in greater detail below). In other words, the resource monitor Y exposes an interface which allows the application A to interact with the resource N, via the resource monitor Y.

More generally stated, the access system 100 provides a collection of resource monitors 112 that are associated with respective gadgets. Each resource monitor is associated with a particular type of user-owned resource. For example, the resource monitor X may be associated with different types of available printers, the resource monitor Y may be associated with different types of available cameras, and so on.

In other cases, a single resource monitor can implement two or more related gadgets. Further, in some cases, a single composite resource monitor (and associated composite gadget) may mediate access to two or more types of user-owned resources. For example, a composite resource monitor may provide access to both a camera device and a location device (e.g., a GPS device).

The access system 100 can isolate each resource monitor (and associated gadget) from each other. Further, the access system 100 can isolate each application from any resource monitor that presents gadgets which are embedded in the application's UI. This means, for instance, that the application A cannot control the pixels that are presented in the display space associated with the gadget 110; nor can the resource monitor Y control the pixels that are presented in the application UI 108. Further, as will be explained below in greater detail, in some cases, the access system 100 can isolate a resource monitor from content that appears in a gadget that is provided by the resource monitor. All of these provisions reduce the opportunities by which a malicious application or other entity may gain improper access to user-owned resources. Informally stated, these provisions reduce the “attack surface” of particular operations performed by the access system 100 or particular features of the access system 100.

The resource monitors 112 can be implemented in different ways. In one merely illustrative case, each resource monitor corresponds to a code module that runs on a layer between the applications 102 and an operating system 114 of the user device or other application-execution environment. In one implementation, a developer or other software provider can provide certain resource monitors as complementary functionality to the operating system 114. In addition, or alternatively, any user may independently install additional resource monitors, obtained from any source, such as a remote resource monitor (RM) store 116. To complement this manner of operation, the access system 100 can include functionality which allows the user to query the access system 100 to discover what resource monitors 112 have been installed in the access system 100.

Consider next the implementation of IBAMs as logic for detecting permission-granting (PG) input sequences. As stated above, a PG input sequence refers to a telltale action performed by the user while interacting with an application, using one or more input mechanisms. The access system 100 correlates each recognized gesture to a particular access-related action that affects a particular user-owned resource. For example, the access system 100 can interpret a first gesture as a request to copy data from an application into a clipboard store. The access system 100 can interpret a second gesture as a request to “paste data,” i.e., to copy data from the clipboard store into the application, and so on. Beyond these types of narrowly-drawn access privileges, the application does not have rights to access any user-owned resources.

In one implementation, a resource monitor may be associated with each PG gesture. Each resource monitor is further associated with a particular type of user-owned resource. However, in some cases, a single resource monitor can detect two or more PG input sequences. Further, in some cases, a single composite resource monitor may mediate access to two or more types of user-owned resources.

An operating system vendor or other appropriate entity may prescribe a rule that no two resource monitors are permitted to define the same global PG input sequence in different ways. However, an application can “internally” redefine an action to be performed when a user executes a PG input sequence. For example, assume that the access system 100 interprets the simultaneous pressing of the Ctrl and C keys as a request to transfer data from the application to a clipboard store. An application can respond to this gesture by performing some other application-centric function, effectively ignoring the fact that the access system 100 may have also stored data from the application into the clipboard store.

In certain cases, an application can also perform application-centric functions which are related to the functions invoked by the PG input sequences that are recognized by the access system 100. For example, an application can interpret an application-centric PG input sequence “yy” as a request to copy data between sub-modules provided by the application. This internal copy operation, however, does not entail storing the data in the clipboard store unless the user also activates the application-agnostic gesture (e.g., by pressing Ctrl and C) which invokes this function.

The access system 100 can employ yet other IBAMs for assessing the intent of the user to access user-owned resources (besides, or in addition to, the use of gadgets and PG input sequences). In general, an IBAM that mediates access to a system-level resource is referred to as a system-level IBAM, providing by a system-level resource monitor. An IBAM that mediates access to an application-specific resource is referred to as an application-specific IBAM, providing by an application-specific resource monitor.

A.2. An Illustrative Application

The access system 100 can carry out the functions described above in different ways. Generally, the access system 100 provides different functional “actors” that may perform different roles to accomplish an access-related transaction. These actors include at least one application, at least one resource monitor, at least one user-owned resource, and the operating system 114 of the execution environment. The description which follows provides examples in which the access system 100 assigns particular roles to these particular actors when performing particular access-related transactions. However, these examples are set forth by way of illustration, not limitation; other implementations can allocate tasks to the actors in the access system 100 in a different manner than is set forth in the detailed examples.

FIG. 2 shows an application 202 for use in the access system 100 of FIG. 1, such as the application A. As noted above, the application 202 can perform any high-level or low-level function, and can be implemented in any manner. The application 202 can present an application UI (such as the application UI 108 of FIG. 1) by which a user may interact with the application 202 in any manner.

The application 202 can include functionality that enables it to interact with the various components of the access system 100 shown in FIG. 1. For example, the application 202 can include a gadget invocation module 204 for instructing the access system 100 to embed a gadget into its application UI. In one case, the application 202 can implement the gadget invocation module 204 using a code statement or a markup language statement that triggers the access system 100 to display a gadget during the setup of the application UI. (More generally stated, the application 202 can incorporate any mechanism for invoking any type of IBAM for use when interacting with an application 202; but to facilitate description, the application 202 will be described in the context in which the IBAM is a gadget.)

The gadget invocation module 204 can specify various parameters which govern the presentation of the gadget within the application UI. A first parameter can specify the location within the application UI at which the gadget is to be displayed. A second parameter provides an identifier of the user-owned resource associated with the gadget. A third parameter can specify the type of gadget which is to be displayed (and, by implication, the type of function that will be invoked by activating the gadget). An optional fourth parameter can specify the duration of the access rights that will be conferred upon activation of the gadget.

With respect to the duration parameter, in one case, a gadget can confer single-transaction access rights which allow the application 202 to access a user-owned resource for only a single transaction (such as a single camera access). In another case, the gadget can confer session-based access rights which allow the application 202 to access a user-owned resource until an application session terminates, e.g., which may be triggered by a user closing the application 202. In another case, the gadget can confer scheduled access rights which allow the application 202 to access a user-owned resource based on at least one scheduling condition, such as by allowing the application 202 to access the user-owned resource at a particular time or times, and/or at a particular location or locations. In another case, the gadget can confer permanent access rights to a user-owned resource that extend over multiple application sessions. These examples are cited by way of illustration, not limitation. Further, the access system 100 can also permit a user to expressly revoke any type of extended permission granted to the application 202, regardless of whether the application 202 is running at the time of revocation. (Extended types of permission include session-based, scheduled, and permanent access rights.)

For example, the gadget invocation module 204 can be implemented by sending a system call EmbedACG( ) to the operating system 114. For instance, the statement EmbedACG((x, y), “camera”, “take-picture”, one-time”) instructs the access system 100 to present a gadget at the location (x, y) within an application UI provided by the application 202. The gadget interacts with the camera (“camera”). The gadget type is “take-picture,” meaning that it operates to push a picture captured by the camera to the application 202. And its duration is “one-time,” meaning that the permission that is invoked upon activating the gadget lasts for only a single picture-taking instance. That is, the user can capture multiple pictures by pressing the gadget multiple times.

The application 202 may also include a permission-checking module 206. The permission-checking module 206 determines whether a child application, embedded in the application 202 (if any), is permitted to utilize the IBAM. In FIG. 3, for instance, a gadget 302 is embedded in an application B UI 304, which, in turn, is embedded in an application A UI 306. An application B controls application B UI 304, while an application A controls application A UI 306. Assume that the application 202 (of FIG. 2) corresponds to application A. The permission-checking module 206 of application A determines whether the application B is permitted to embed the gadget 302. The permission-checking module 206 can make this determination based on a static or dynamic permission setting provided by the application A.

Section B provides details pertaining to one manner of operation of a permission-checking protocol performed by the operating system 114. By way of overview, the permission-checking protocol grants permission to the application 202 to embed the gadget if: (a) the application UI provided by the application 202 is not nested in any other application UI provided by any other application; or (b) the application UI provided by the application 202 is nested in at least one ancestor application UI, but the ancestor application(s) which control these ancestor application UI(s) permit the application 202 to embed the gadget into its application UI.

For example, again consider FIG. 3. The application B which provides the application B UI 304 is not a top-level application. The permission-checking protocol will permit the gadget 302 to be embedded in the application B UI 304 only if the application A which provides the application A UI 306 grants this permission. Although not shown, the application B UI 304 can be nested in further layers of application UI. In this case, the permission-checking protocol can iterate the above-described permission-checking behavior one or more times, until reaching the outmost embedding application in the chain of nested applications.

The operating system 114 can trigger the permission-checking module 206 in the application A (of FIG. 3) by sending it a CheckNestedPermission upcall. This upcall can specify the following parameters: a Window ID (WindowId) which allows a multi-window application to determine which window should respond to the upcall; the ID of the application B (nestedApp); and the type of the gadget 302 (acgType) to be embedded. The permission-checking module 206 can respond to the upcall by sending a response which indicates whether the gadget 302 can be embedded in application B. If the application A is embedded in another application, then the operating system 114 can send a CheckNestedPermission upcall to that embedding application, and so on.

The application 202 can also include a data handling module 208 for handling various operations that involve the manipulation of data, in response to the various upcalls sent by the operating system 114 (note that the operating system 114 is the entity which sends all upcalls). For example, the data handling module 208 can receive a PushContent upcall which instructs the application 202 to accept data sent by the operating system 114. The data handling module 208 can receive a PullContent upcall which instructs the application 202 to supply data to the operating system 114. The data handling module 208 can also receive an IsDraggable upcall and/or an IntermediateEvent upcall when the access system 100 is employed to perform a drag-and-drop operation, as will be explained in greater detail at a later juncture of this explanation. The parameters of these upcalls can specify: the Window ID (WindowId); the nature of the data manipulation operation to be performed (eventName); and one or more other case-specific arguments (eventArgs). For example, in one case, eventArgs can specify the data to be pasted into the application 202 in a PushContent upcall.

FIG. 2 also indicates that the application 202 can include any additional logic 210 for performing any respective function(s).

A.3. An Illustrative Resource Monitor

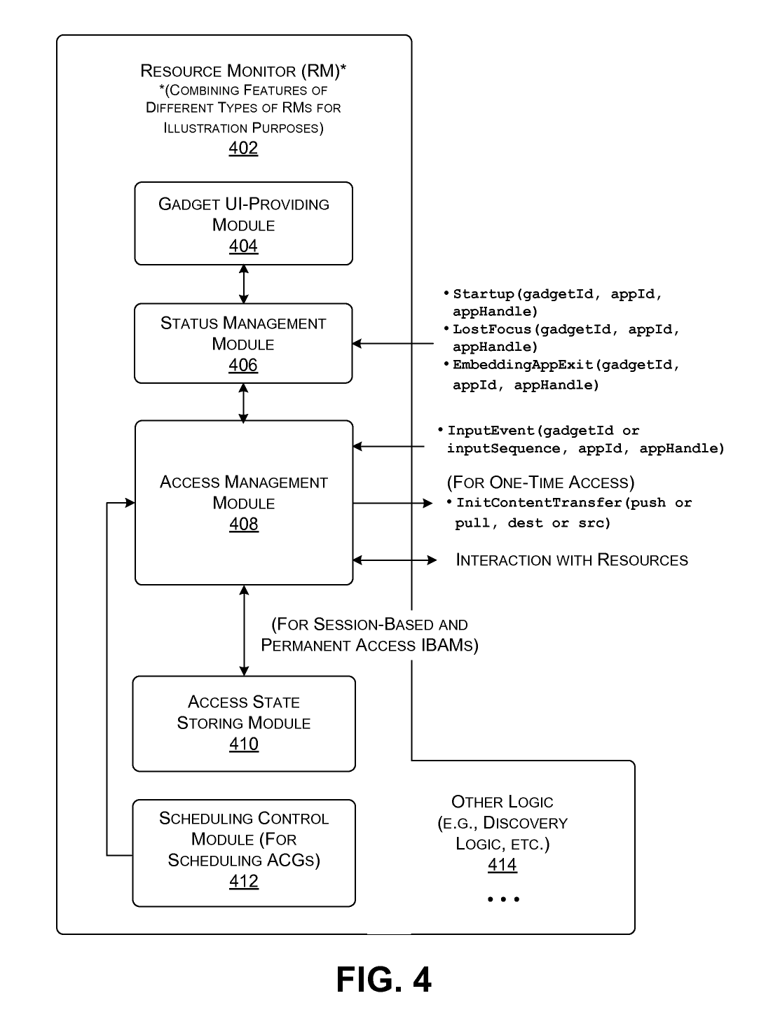

FIG. 4 shows an illustrative resource monitor 402 for use in the access system 100 of FIG. 1. For example, the resource monitor 402 may pertain to the resource monitor Y shown in FIG. 1. As explained above, that resource monitor Y provides one or more gadgets that mediate application A's access to the user-owned resource N.

The resource monitor 402 can include functionality that enables it to interact with the various components of the access system 100 shown in FIG. 1. For example, the resource monitor 402 can include a gadget UI-providing module 404 which provides whatever gadget (or gadgets) is (or are) associated with the resource monitor 402. This presumes that the resource monitor 402 provides a gadget. In the case in which the resource monitor 402 is associated with a PG input sequence, the resource monitor 402 can include functionality which describes the behavior associated with the PG input sequence. Although not shown, the resource monitor 402 can also include functionality which registers the characteristics of its gadget and/or PG input sequence with the operating system 114.

The resource monitor 402 also includes a status management module 406 for monitoring events which affect the status of the gadget or the PG input sequence. For example, the status management module 406 can receive a Startup upcall from the operating system 114 that instructs the resource monitor 402 to commence its operation, e.g., by providing a gadget or activating a PG input sequence detection process. The status management module 406 can also receive a LostFocus upcall from the operating system 114 which indicates that the user is no longer actively interacting with the gadget provided by the resource monitor 402. The status management module 406 can also receive an EmbeddingAppExit upcall from the operating system 114 which indicates that the user has closed the application associated with the gadget or PG input sequence being handled by the resource monitor 402. The gadgetId parameter identifies a particular type of gadget, the appId parameter identifies the application in which the gadget is embedded, and the appHandle provides a handle of a running instance of the application.

An access management module 408 handles tasks relating to the mediated transfer of data from a source to a destination. The access management module 408 performs its operation in response to receiving an InputEvent upcall from the operating system 114. The operating system 114, in turn, sends the InputEvent upcall when a user interacts with the gadget associated with the resource monitor 402 or performs the PG input sequence associated with the resource monitor 402.

The access management module 408 can respond to the InputEvent upcall in at least one of three ways, depending on the type of gadget or PG input sequence that is associated with the resource monitor 402 in question. To simplify the illustration, FIG. 4 shows a single resource monitor 402 which includes functionality for addressing all three methods of data transfer. But, in practice, a resource monitor 402 need only incorporate the functionality which addresses its particular mode of data transfer.

In a first case, the gadget or PG input sequence grants an application session-based or permanent access to the user-owned resource associated with the resource monitor 402. To do this, the access management module 408 makes an appropriate change in an access state storing module 410 to indicate that the application in question (identified by appId) is to be given appropriate access to the user-owned resource (where the duration of that access is conveyed by the type of gadget or PG input sequence that has been invoked).

In a second case, the gadget or PG input sequence grants an application one-time access to a particular user-owned resource. To do this, the access management module 408 sends an InitContentTransfer call to the operating system 114. That transfer call instructs the operating system 114 to push or pull appropriate data to or from a destination location (dest) or source location (src), respectively.

In a third case, the gadget or PG input sequence grants an application scheduled access to a particular user-owned resource, such as by granting the application access to the user-owned resource at a particular time or times, and/or at a particular location or locations. In this case, the access management module 408 automatically generates input events, rather than receiving such upcalls from the operating system 114. That automatically-generated event simulates the user's actuation of a gadget or PG input sequence in accordance with the designated scheduling condition(s). A scheduling control module 412 stores the scheduling condition(s) which govern the timing at which the access management module 408 is invoked in this manner. (Alternatively, the operating system 114 can implement the scheduling control module 412.) A user may prefer to grant scheduled access, rather than permanent access, to more effectively promote the goal of least-privileged access, and thereby reduce the risk of improper access to user-owned resources.

Finally, the resource monitor 402 can include any other logic 414 for performing any other respective function(s). For example, the other logic 414 can include a discovery mechanism that enables applications to discover the user-owned resources that are associated with the resource monitor 402. For example, suppose that the resource monitor 402 mediates access to all cameras installed by the user device 106. The discovery mechanism may store information regarding these available cameras. The application can query the discovery mechanism to access this information for any reason. Next suppose that the user or some other agent installs another type of camera in the user device 106. The discovery mechanism can add that new camera to its description of available cameras. Further, the gadget UI-providing module 404 can optionally incorporate new UI features that address any newly-encountered control features that may be used by the new camera device.

A.4. An Illustrative Operating System

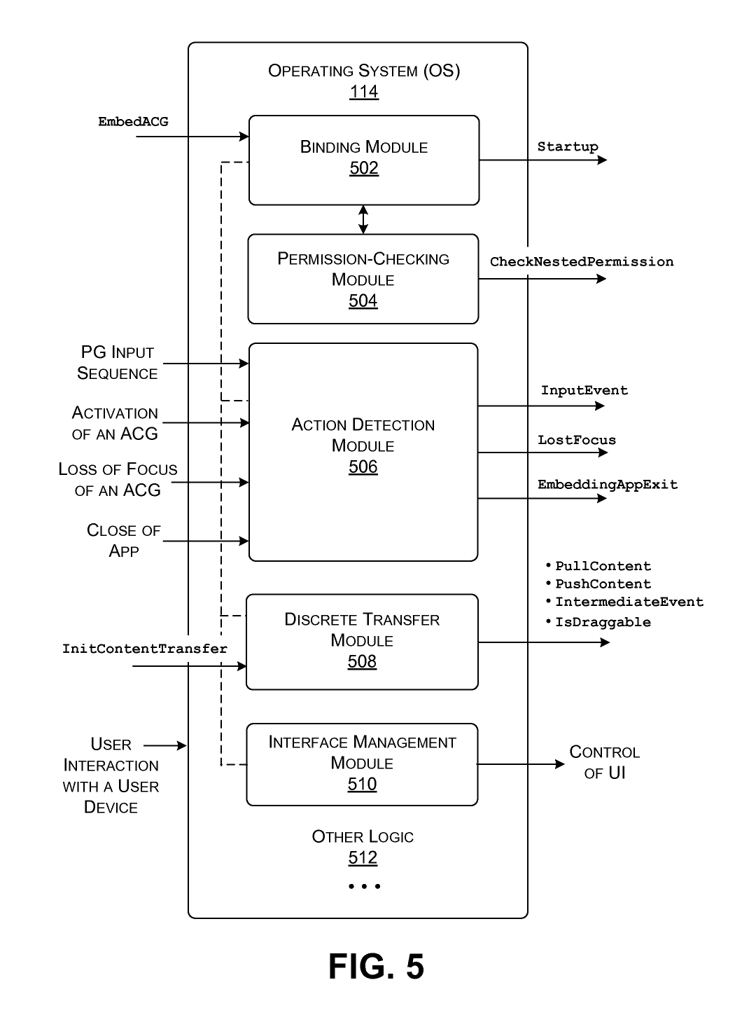

FIG. 5 shows one implementation of the operating system 114 that may be used in the access system 100 of FIG. 1. Generally, the operating system 114 manages the input mechanisms and output mechanism of the user device 106 or other operating environment associated with the access system 100. The operating system 114 also manages the utilization of basic system resources (such as CPU resources, memory resources, bus resources, and communication), which can be considered non-user-owned resources. But to facilitate description, FIG. 5 emphasizes only those particular features of the operating system 114 that serve a role in allowing applications 102 to access the user-owned resources 104. In one implementation, the various features shown in FIG. 5 can be implemented by kernel-level functionality provided by the operating system 114.

To begin with, the operating system 114 includes a binding module 502 which responds to an EmbedACG call, made by an application, to embed a particular gadget within the application UI of the application, or to commence detection using a particular PG input sequence. For the case of gadgets, the binding module 502 responds to the EmbedACG call by starting the appropriate resource monitor process, binding embedded region(s) of the UI space to the resource monitor, and notifying the resource monitor of the activation of the gadget using a Startup upcall.

The binding module 502 can also work in conjunction with a permission-checking module 504 to determine whether a particular application is permitted to use a gadget or PG input sequence. It performs this task by sending a CheckNestedPermission upcall to any ancestor application(s) in which the specific application is nested. Section B provides further details regarding the operation of the permission-checking module 504.

An action detection module 506 detects various events that may occur which affect the access system 100, and sends appropriate upcalls to the appropriate resource monitor(s) in response. For example, the action detection module 506 can detect whenever the user activates a gadget or PG input sequence (e.g., by clicking the gadget with a mouse device, contacting a touch-sensitive gadget with a finger and/or stylus, producing the triggering input events associated with a PG input sequence, etc.). In response, the action detection module 506 will send an InputEvent upcall to the appropriate resource monitor (which is associated with the gadget or PG input sequence). That InputEvent causes the resource monitor to mediate a one-time grant of access rights or an extended grant of access of rights, depending on the type of IBAM that has been activated. In another case, the action detection module 506 detects when a user stops actively interacting with a gadget, and, in response, sends a LostFocus upcall to the appropriate resource monitor. In another case, the action detection module 506 detects when the user closes an application in which a gadget or PG input sequence was active, and, in response, sends an EmbeddingAppExit upcall to the appropriate resource monitor.

A discrete transfer module 508 executes a discrete transfer operation by sending a PullContent upcall to an application or other principal, a PushContent upcall to an application or other principal, or both a PullContent upcall and a PushContent upcall. The discrete transfer module 508 also can also send the IsDraggable and IntermediateEvent upcalls in the course of performing a drag-and-drop operation (as will be described in Section B). Any resource monitor can trigger the operation of the discrete transfer module 508 by sending it an InitContentTransfer system call.

Finally, the operating system 114 can include an interface management module 510 which implements various security-related safeguards. For example, the interface management module 510 can enforce a policy which achieves the default isolation behavior described in Section A.1.

Further, the interface management module 510 does not permit the user to interact with a gadget unless the gadget is fully visible (meaning that no object overlays any part of the gadget). For example, the interface management module 510 can display the gadget in a grayed-out mode of presentation if the gadget is at least partially obscured by another display object. This provision reduces the chances that a malicious entity may overlay information on top of a gadget with the intent of fooling the user into clicking on the gadget, when the user would not otherwise perform this action. The interface management module 510 can also allow a user to interact with a gadget only after it has been displayed in the same location for a minimum amount of time (e.g., 200 ms in one example).

As another safeguard, the interface management module 510 can dispatch user input events originating from physical devices (e.g., keyboard, touchscreen, mouse, or microphone) only to the in-focus application. This means that no application can artificially generate user input for other applications. Thus, when the gadget is in focus and the user acts on it, the user's input, dispatched to the corresponding resource monitor, is guaranteed to be authentic. As a related safeguard, the interface management module 510 can manage the visual feedback sent to a gadget, e.g., by ensuring that a cursor is displayed when the user hovers over a gadget. This provision can prevent, for example, a rogue application from confusing the user as to where the user is clicking within a UI space.

The above-described restrictions pertain to one particular implementation, rather than outright prohibitions. That is, other implementations can remove or relax the above restrictions in any manner that is deemed appropriate for a particular environment. Alternatively, or in addition, other implementations can introduce additional restrictions and/or increase the restrictiveness of existing constraints (e.g., by increasing the minimal amount of time that a gadget is required to be visible before input can be accepted).

The interface management module 510 can also host functionality which displays a control panel to the user, upon request from the user. The control panel displays the access rights granted to each application at a particular point in time. The user may also interact with the control panel to revoke any prior-granted permission. More specifically, the user can revoke the access rights that have been granted to an application even though, at the present time, the application has been closed and is no longer running.

The operating system 114 also includes any other logic 512 for performing any other functions.

As a final note, any of the functions attributed to the operating system 114 can also (or alternatively) be performed by other components of the access system 100, such as the resource monitors 112. Alternatively, or in addition, any of the above-described functions attributed to the resource monitors 112 can instead be performed by the operating system 114 or other components of the access system 100.

A.5. Application-Specific IBAMs

As noted in Section A.1, a resource monitor may mediate access to different types of user-owned resources, such as system-level resources and application-specific resources. Application-specific resources are assets that are hosted by a particular application. This section provides additional information regarding one manner in which the access system 100 can implement application-specific IBAMs, which mediate access to application-specific resources.

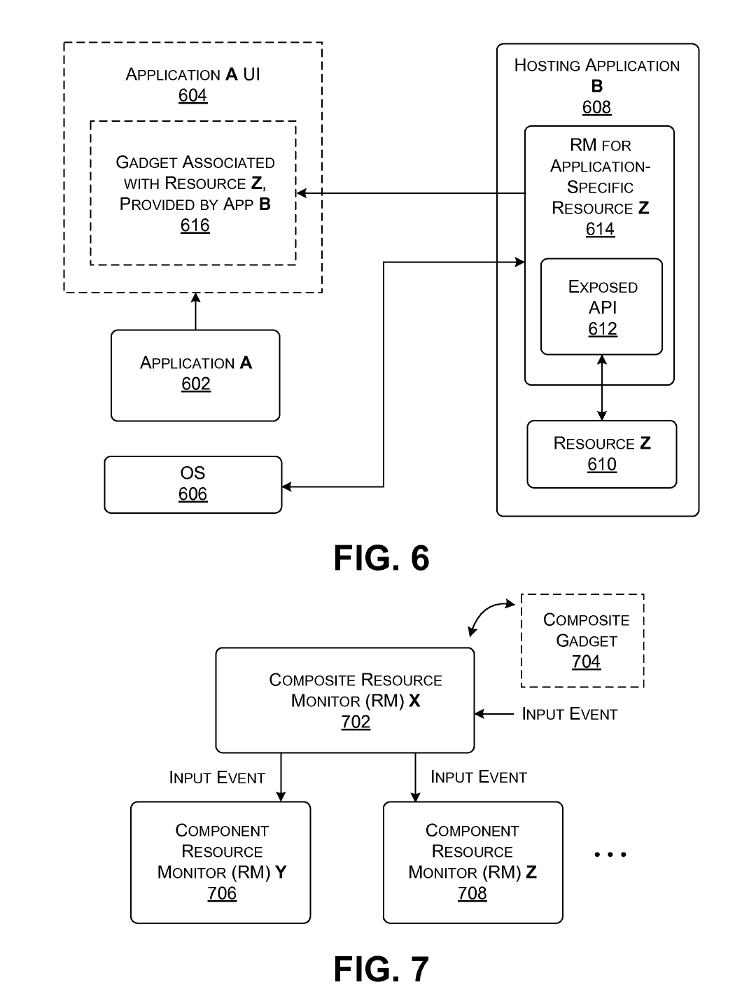

Consider the framework shown in FIG. 6. Here, an application A 602 provides an application A UI 604. Application A 602 runs using the services of operating system 606 in some execution environment. A separate application B 608 provides a resource Z 610 of any type, together an application programming interface (API) 612 that allows external entities (such as the application A 602) to interact with the resource Z 610. For example, assume that application B 608 corresponds to a social network application. The application B 608 may host an API that allows any duly-authorized external entity to read contact list information maintained by its service; in this case, the contact list information corresponds to the resource Z 610.

In the configuration of FIG. 6, the application B 608 exposes a resource monitor 614 which provides an IBAM, such as a gadget 616. Any external entity, such as application A 602, can embed the gadget 616 into its application A UI 604. By doing so, the application B 608 can ensure that a user's request to access a user-sensitive resource is coupled with an assurance of authentic user intent. That is, the application B 608 can be assured that a valid user is properly attempting to access the resource Z 610 if its receives an InputEvent upcall from the operating system 606, which in turn, is triggered by the user's interaction with the gadget 616 in the context of the application A UI 604.

Later sections describe a content-view gadget which represents one example of an application-specific IBAM.

A.6. Composite IBAMs

In the examples set forth above, each IBAM controls access to a single type of user-owned resource. In contrast, a composite IBAM may mediate access to two or more different types of user-owned resources.

FIG. 7 shows a composite resource monitor 702 which provides a corresponding composite gadget 704. The composite resource monitor 702 acts as a proxy. When the use interacts with the composite resource monitor 702, the composite resource monitor 702 will distribute two or more input events to two or more respective component resource monitors (e.g., component resource monitor 706 and component resource monitor 708). The component resource monitor 706 can then interact with its associated user-owned resource, e.g., by either pulling or pushing data from/to this user-owned resource. Similarly, the component resource monitor 708 can interact with its associated user-owned resource, e.g., by either pulling or pushing data from/to this user-owned resource. In this manner of operation, the composite resource monitor 702 simplifies the input actions of the user. For example, consider the case in which an application includes a function which captures a picture from a camera. The picture includes location metadata supplied by a GPS device. Without the use of a composite resource monitor, a user can grant the application permission to perform this function by clicking on two separate gadgets, e.g., a camera gadget and a GPS gadget. With the use of a composite resource monitor, a user can invoke the same permissions by clicking on a single composite gadget.

Suppose that the purpose of the composite resource monitor 702 is to extract information from two user-owned resources, which is sent to a consuming application. In one approach, the access system 100 can be configured such that the access system 100 forwards the extracted data directly to the consuming application. This promotes isolation by preventing the composite resource monitor 702 from gaining access to the data. But in another approach, the access system 100 can forward the data to the composite resource monitor 702, which, in turn, forwards it to the consuming application. Section B provides additional details regarding the use of composite resource monitors.

A.7. Implementation Details

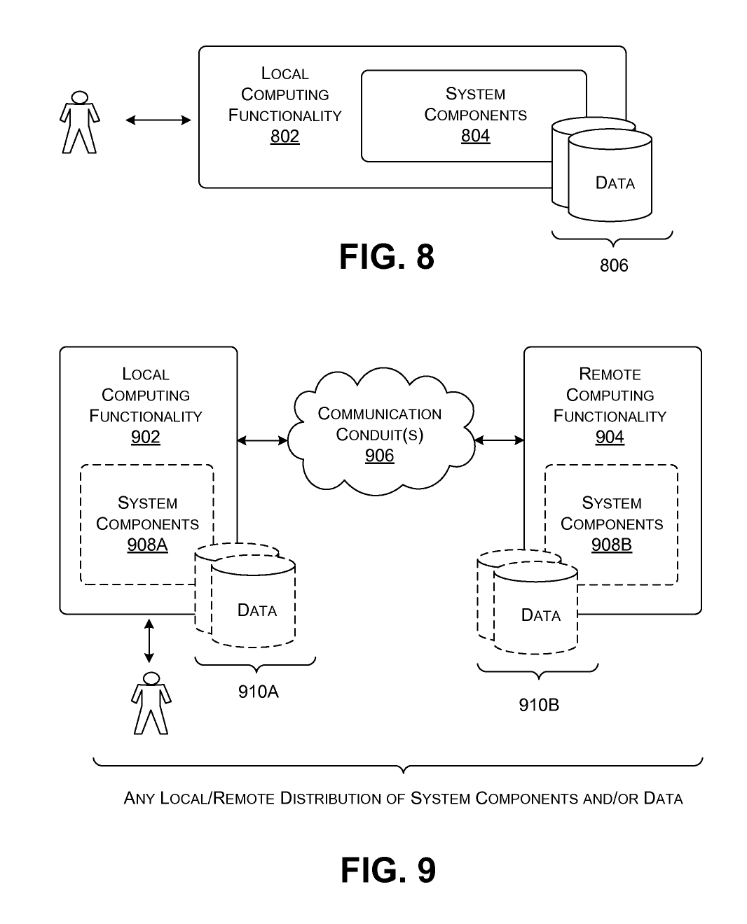

FIG. 8 shows a stand-alone implementation of the access system 100 of FIG. 1. In this case, local computing functionality 802 includes system components 804 and data 806 which implement the various features of the access system 100 described above. In one implementation, the local computing functionality 802 can represent the user device 106 of FIG. 1, e.g., which may correspond to any type of stationary computing device or portable computing device.

FIG. 9 shows a distributed implementation of the access system 100 of FIG. 1. In this case, local computing functionality 902 is coupled to remote computing functionality 904 via a communication conduit 906. The local computing functionality 902 includes system components 908A and data 910A which implement some functions of the access system 100, while the remote computing functionality 904 includes system components 908B and data 910B which implement other functions of the access system 100.

More specifically, the functionality associated with the applications 102, resource monitors 112, and user-owned resources 104 can be allocated between the local computing functionality 902 and the remote computing functionality 904 in any manner. For example, an application A can be implemented by code stored in the user device 106, and/or by code stored at a remote site. In addition, the resource monitor Y which provides the gadget 110 can be physically implemented by code in the user device 106 and/or by code provided at a remote site. The resource monitor Y may be implemented at a remote site, for instance, when a remote application hosts an application-specific gadget. The hosting application (e.g., application A) can incorporate that application-specific gadget by appropriately making reference to the source of its UI code.

The local computing functionality 902 can be implemented by any type of user device mentioned in Section A.1. The remote computing functionality 904 can be implemented by one or more server computers and associated data stores. The communication conduit 906 can be implemented by a local area network, a wide area network (e.g., the Internet), or a combination thereof.

A.8. Illustrative Gadgets

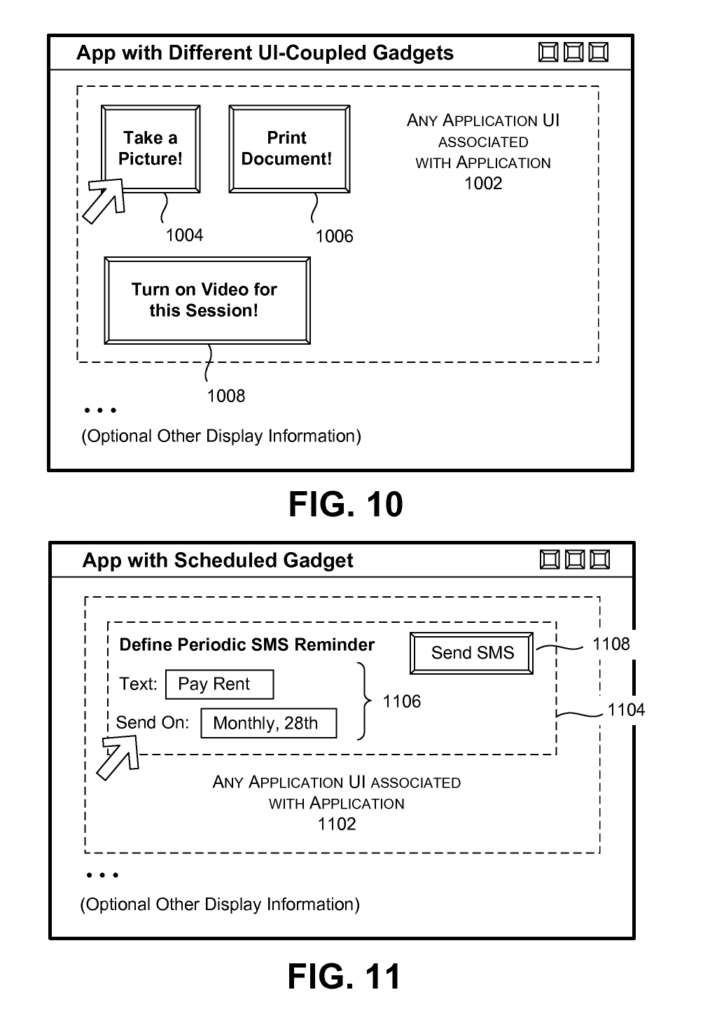

FIGS. 10-16 show gadgets that can be implemented by different types of resource monitors. The different gadgets control access to different types of user-owned resources. Further, the different gadgets confer different types of access rights to applications which embed these gadgets. As a general prefatory note, all aspects of the appearance and functionality of the gadgets are to be understood as representative, rather than limiting.

FIG. 10 shows an application UI 1002 presented by an application. The application performs any function. The application UI 1002 embeds three different gadgets (1004, 1006, 1008). The first gadget 1004 provides one-time access to a camera. That is, in response to activation of this gadget 1004, the access system 100 provides a picture to the application. The second gadget 1006 gives the application one-time access to a printer. In response to activation of this gadget 1006, the access system 100 pulls print data (corresponding to a single print job) from the application and sends it to the printer. The third gadget 1008 grants the application rights to utilize a video camera throughout the remainder of an application session. The application loses rights to access the video camera when the application is closed or the user expressly terminates the access rights of the application (e.g., through an appropriate control panel or the like).

FIG. 11 shows an application UI 1102, provided by an application, which embeds a scheduling-type gadget 1104. The scheduling-type gadget, in turn, incorporates two gadget parts. A first gadget part 1106 defines the timing at which the access system 100 will send an SMS message (e.g., the 28^{th} of each month), together with the text of the SMS message (e.g., “Pay Rent”). The second gadget part 1108 invokes a SMS resource monitor. Upon activation, the SMS resource monitor will send the SMS message “Pay Rent” on the 28^{th} of each month, as per the scheduling condition defined by the first gadget part 1106.

Another potential use of a scheduling-type gadget is to perform a periodic backup operation. Another use is to perform a periodic update operation, e.g., by extracting updates from a source entity having dynamically-changing information content. Another use is to perform some activity upon entering a particular region, and so on.

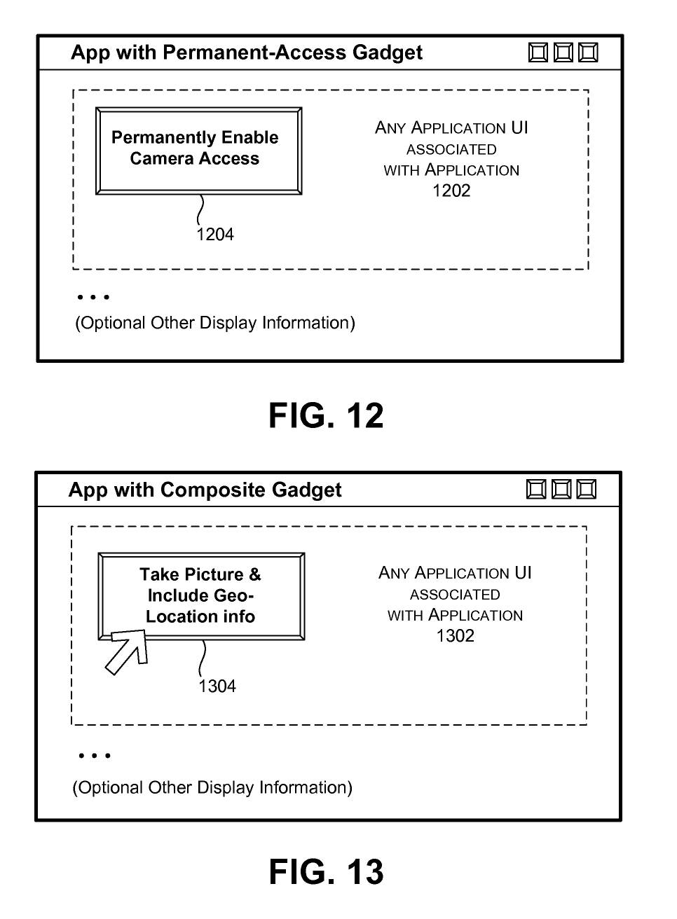

FIG. 12 shows an application UI 1202, provided by an application, which embeds a gadget 1204 which grants permanent access to a camera. As mentioned above, a user can expressly revoke this permission at any time.

In general, the single-transaction access gadgets (1004, 1006, 1008) of FIG. 10 are UI-coupled gadgets because the access control rights that they invoke are strongly linked to the user's interaction with the application UI 1002. The gadget 1104 of FIG. 11 and the gadget 1204 of FIG. 12 are not UI-coupled because the access control rights that they invoke exist for an extended period of time independent of the user's interaction with the application user interfaces (1102, 1202). Further, the examples of FIGS. 10-12 conform to the principle of least-privileged access to varying extents, the single-transaction access gadgets (1004, 1006, 1008) adhering most closely to this principle, and the permanent access gadget 1204 of FIG. 12 adhering least to the principle.

FIG. 13 shows an application UI 1302, provided by an application, which embeds a composite gadget 1304. The composite gadget 1304 provides a single-transaction access to both a camera and a GPS device. That is, in response to clicking on this gadget, the application which provides the application UI 1302 will receive a picture, taken by the camera, that incorporates location metadata provided by the GPS device. Alternately, the application may receive the picture and the location data as two discrete data items.

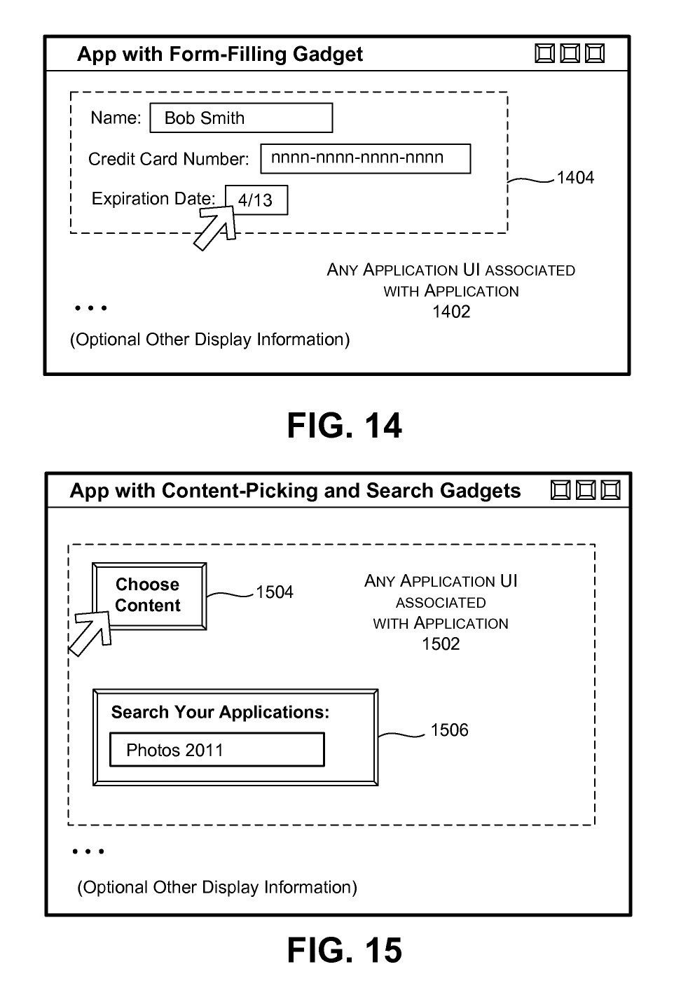

FIG. 14 shows an application UI 1402, provided by an application, which embeds a form-filling gadget 1404. The form-filling gadget 1404 receives data supplied by the user of any type. In the context of a credit transaction, for instance, the form-filling gadget 1404 may receive the user's name, credit card number, credit card expiration date, etc. The access system 100 is prompted to store the input data when the user closes the form-filling gadget 1404. In another implementation, each text field input box of the form-filling gadget 1404 can correspond to a separate form-filling gadget, with or without its prefatory labeling (e.g., the label “Credit Card Number,” etc.). The latter option permits applications to flexibly assemble different form-filling gadgets to collect different combinations of information from an end user.

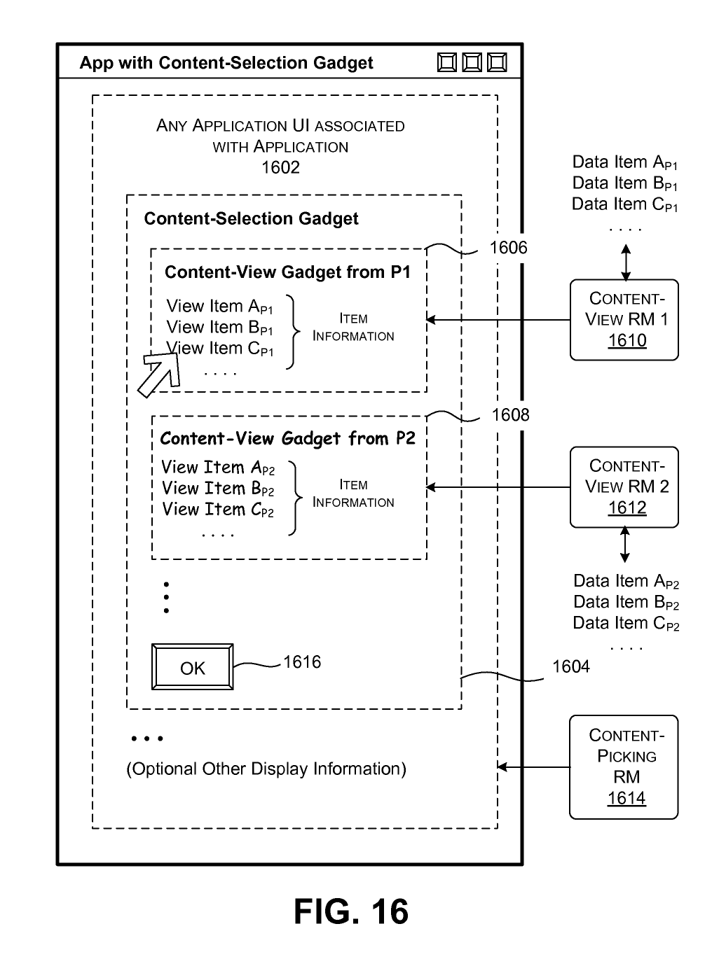

FIG. 15 shows an application UI 1502, provided by an application, which embeds a content-picking gadget 1504 and a search gadget 1506. Activation of either gadget (1504, 1506) prompts the access system 100 to display the context-selection gadget 1604 shown in FIG. 16 (to be described below). More specifically, activation of the content-picking gadget 1504 prompts the access system 100 to display item information comprising one or more view items. The view items, in turn, are associated with respective data items provided by one or more content-providing entities. To be more concrete, in one case, the view items may correspond to file names, and the data items may correspond to the files themselves. In another case, the view items may correspond to information which identifies user contacts (such as by providing the names of the contacts), and the data items may correspond to the complete contact information associated with the contacts (such as by providing contact numbers and addresses associated with the contacts). Activation of the search gadget 1506 prompts the access system 100 to identify view items, corresponding to respective data items, which match a search term input via the search gadget 1506. A content-provider entity refers to any functionality which provides data items that can be accessed by duly authorized entities.

FIG. 16 shows an application UI 1602, provided by an application, which displays a content-selection gadget 1604. Suppose that the content-selection gadget 1604 is displayed in response to the activation of the content-picking gadget 1504 of FIG. 15. The content selection gadget 1604 includes view items corresponding to respective data items, where those data items are hosted by one or more content-providing entities.

More specifically, the content-selection gadget 1604 operates as a container which encompasses one or more content-view gadgets (1606, 1608, . . . ). Each content-view gadget represents an application-specific gadget that is hosted by an application-specific resource monitor, provided, in turn, by a particular content provider. For example, a content-view resource monitor 1610 provides the content-view gadget 1606, and a content-view resource monitor 1612 provides the content-view gadget 1608, etc. Each content-providing resource monitor (1610, 1612) can apply a provider-specific look and feel to its content-view gadget (1606, 1608), optionally together with provider-specific functionality. FIG. 16 illustrates this point by showing that the item information in the content-view gadget 1606 is presented in a different font compared to the item information in the content-view gadget 1608.

In contrast, a content-picking resource monitor 1614 provides the shell content-selection gadget 1604 (and, in one implementation, also provides the content-picking gadget 1504 of FIG. 15). The resource monitors (1610, 1612, 1614) need not originate from sources that are located at the same sites. In one implementation, the content-picking resource monitor 1614 and embedding application (which provides the application UI 1602) can directly access neither the view items nor the data items. Rather, the operating system 114 selectively pushes the data item(s) that the user selects to the application via the content-selection gadget 1604, as will be clarified in Section B.

In one manner of operation, the user can select one or more view items from any of the content-view gadgets (1606, 1608), where, again, the view items correspond to respective data items provided by the content-provider entities. The user may then activate an OK command button 1616. The access system 100 then transfers the selected data items from the appropriate content-provider entity(ies) to the application which provides the application UI 1602. In an alternative mode of operation, a user can use a drag-and-drop operation to move a view item in the content-selection gadget 1604 to any destination location. This results in the transfer of a corresponding data item to the designated location. In an alternative mode of operation, a user can directly click on (or otherwise activate) an entry in one of the content-view gadgets (1606, 1608). Still other modes of operation are possible.

The above-illustrated gadgets are representative, rather than exhaustive of the different types of gadget that can be used in a particular environment. However, in one approach, the access system 100 may accommodate a finite number of access control gadgets which are authorized to work in conjunction with the operating system 114.

In another environment, the access system 100 can permit any entity (such as a developer) to customize one or more aspects of a gadget. For example, the access system 100 can permit an entity to customize a limited set of properties of a gadget, such as its color, size, font etc. The access system 100 may also restrict the values that can be assigned to these properties.

In another case, the access system 100 can allow an entity to modify any gadget in a more free-form and arbitrary manner, and/or to perhaps invent entirely new gadgets. In this circumstance, an authoring entity may be expected to submit a modified or new gadget to an appropriate administrative entity associated with the access system 100, for the purpose of vetting that gadget. If the gadget is accepted, it can be placed in the RM store 116 for others to examine, download, and use.

B. Illustrative Processes

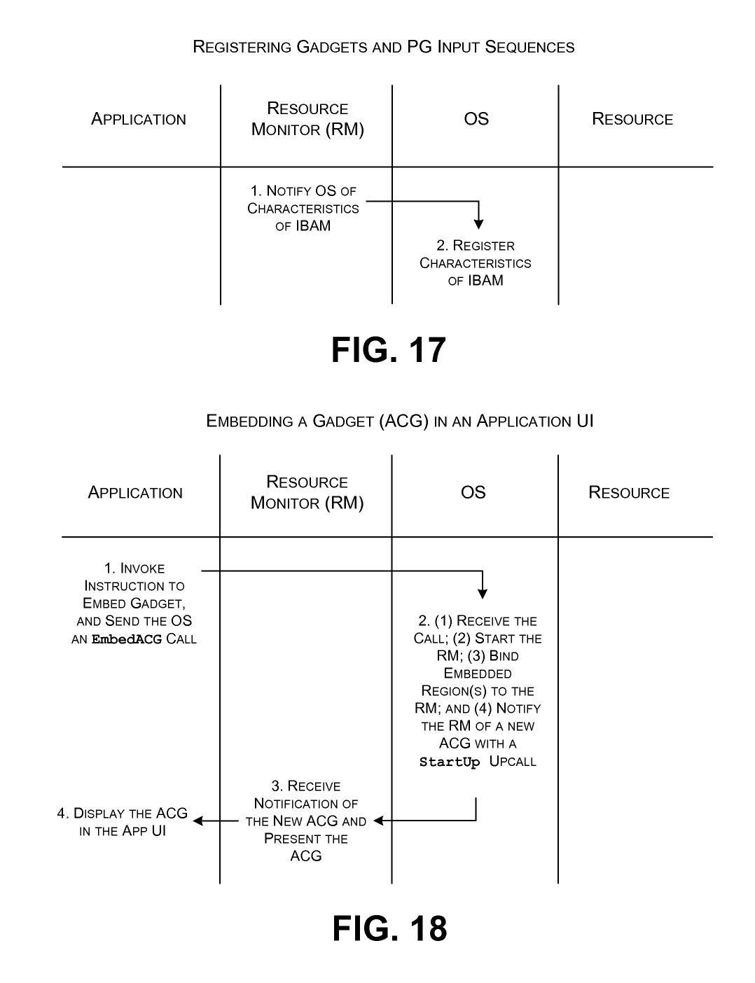

FIGS. 17-26 show procedures which describe one manner of operation of the access system 100 of FIG. 1. Since the principles underlying the operation of the access system 100 have already been described in Section A, certain operations will be addressed in summary fashion in this section.

As a general qualification, the procedures of this section describe concrete actions that are performed by particular components within the access system 100 (e.g., applications 102, resource monitors 112, user-owned resources 104, and the operating system 114). However, this allocation pertains to only one representative implementation. Other implementations can assign different roles to different respective components, compared to the examples which follow. Further, other implementations can vary the ordering of operations performed by the components, compared to the examples which follow. Finally, to facilitate description, the procedures illustrated in the drawings may omit certain interactions and operations. For example, the operating system 114 plays some role in processing all input data and presenting all output data; but the procedures highlight only those functions performed by the operating system 114 which pertain to the access-related role it serves within the access system 100 of FIG. 1.

FIG. 17 shows a procedure whereby a resource monitor notifies the operating system 114 of its capabilities. That is, in operation (1), the resource monitor notifies the operating system 114 of the characteristics of the particular IBAM that it controls, e.g., either a gadget or a PG input sequence. In operation (2), the operating system 114 registers the characteristics of the IBAM, if, in fact, the particular IBAM is permitted by the access system 100.

FIG. 18 shows a procedure whereby the access system 100 activates a gadget. In operation (1), the application sends an EmbedACG system call to the operating system 114. For example, the application can send this call during the loading of an application UI which embeds a gadget. In operation (2), the operating system 114 receives the call, starts the resource monitor, binds a region or regions of the UI space to the resource monitor, and sends a Startup upcall to the resource monitor. In operation (3), the resource monitor receives the Startup upcall and presents the gadget. In operation (4), the application displays the application UI which includes the embedded gadget.

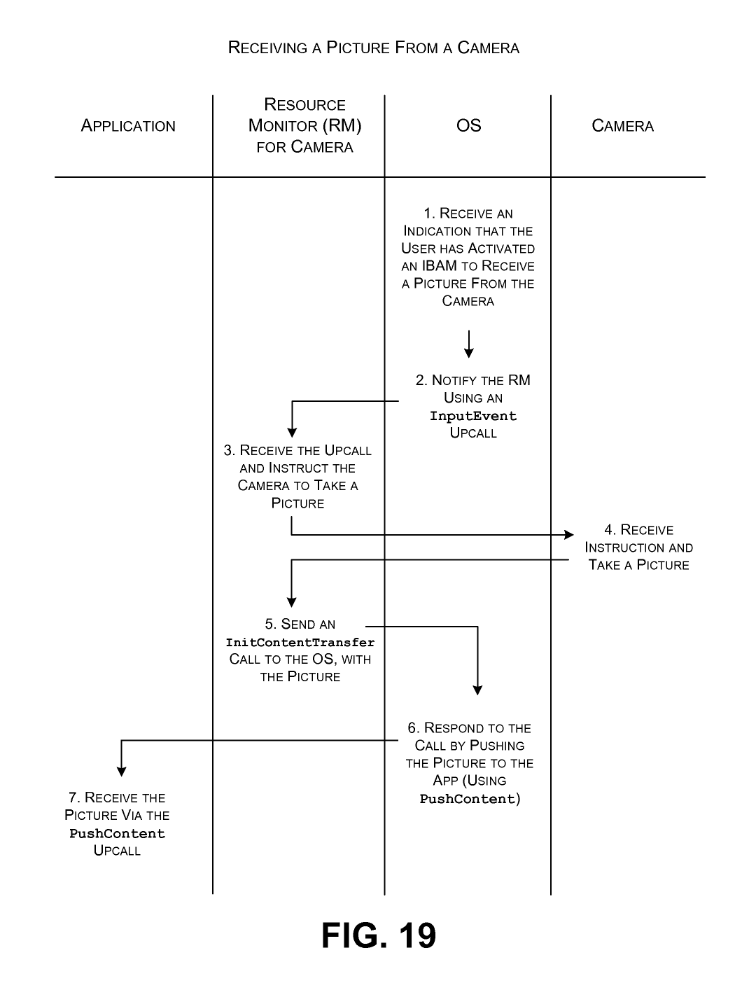

FIG. 19 shows a procedure whereby the access system 100 grants an application one-time access to a camera. In operation (1), the operating system 114 receives an indication that the user has activated an IBAM, e.g., by activating either a gadget or performing a PG input sequence. In operation (2), the operating system 114 sends an InputEvent upcall to the resource monitor of the camera. In operation (3), the resource monitor receives the upcall and instructs the camera to take the picture. In operation (4), the camera takes a picture and returns it to the resource monitor. In operation (5), the resource monitor sends an InitContentTransfer system call to the operating system 114. In operation (6), the operating system 114 pushes the picture to the application using a PushContent upcall. In operation (7), the application receives the picture.

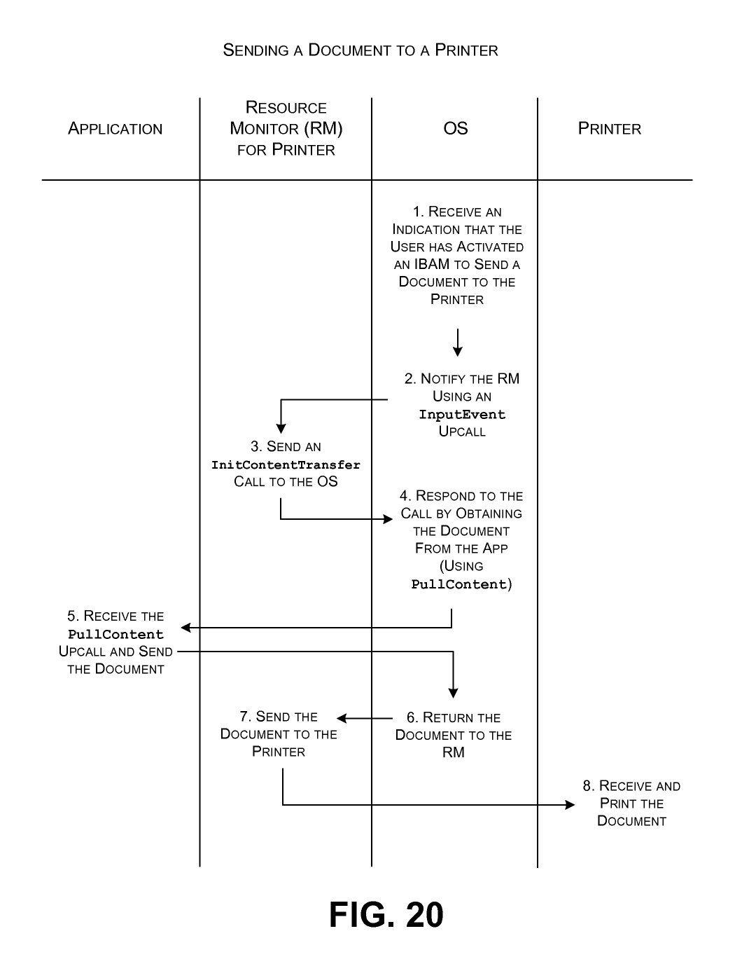

FIG. 20 shows a procedure whereby the access system 100 sends a document (or other finite print job) to a printer. In operation (1), the operating system 114 receives an indication that the user has activated an IBAM, e.g., by activating either a gadget or performing a PG input sequence (e.g., by pressing Ctrl-P). In operation (2), the operating system 114 sends an InputEvent upcall to the resource monitor of the printer. In operation (3), the resource monitor receives the upcall and sends an InitContentTransfer system call to the operating system 114. In operation (4), the operating system 114 issues a PullContent upcall to the application to obtain the document. In operation (5), the application provides the document. In operation (6), the operating system 114 receives the document and sends it to the resource monitor, as a return response to the InitContentTransfer call. In operation (7), the resource monitor receives the document and sends it to the printer. In operation (8), the printer prints the document.

The access pattern described in FIGS. 19 and 20 can be applied to other access tasks with respect to other types of user-owned resources. For example, consider a form-filling operation (not illustrated in the drawings). In this case, the user may fill out at least part of a form-filling gadget, such as the form-filling gadget 1404 shown in FIG. 14. When the user leaves the form-filling gadget, the operating system 114 detects a LostFocus event and sends a LostFocus upcall to the resource monitor associated with the form-filling gadget. The resource monitor responds to this upcall by updating an autocomplete store and passing the new text to the application using an InitContentTransfer call.

Next consider a cut (or copy) and paste operation. The access system 100 can use the type of procedure of FIG. 20 to extract cut (or copied) content from the application and store it in a clipboard store; this operation is invoked in response to the user's activation of a cut (or copy) gadget. In one implementation, the resource monitor associated with the clipboard store can manage the state of the clipboard store. Then the access system 100 can use the procedure of FIG. 19 to push content from the clipboard store to a designated target location, such as a location within the application UI provided by an application; this operation is invoked in response to user's activation of a paste gadget.

Next consider a drag-and-drop operation. The access system 100 can use the type of procedure of FIG. 20 to extract designated content from the application and store it in a transitory clipboard store; this operation is invoked in response to the user's activation of a mouse-down gesture with a mouse device, followed by some movement of the mouse device. To determine whether the user has designated a valid object to be dragged, the operating system 114 can send an IsDraggable upcall to the application. The application responds by identifying whether the object that the user is pointing to with the mouse cursor can be dragged. Then the access system 100 can then use the procedure of FIG. 19 to push content from the transitory clipboard store to a designated target location, such as a particular location in the application UI provided by an application; this operation is invoked in response to user's activation of a mouse-up gesture. During the course of the dragging operation, the operating system 114 can send IntermediateEvent upcalls to the application. These IntermediateEvent upcalls inform the application when the cursor position leaves a window, enters a window, or moves within a window. The application can respond to these IntermediateEvent upcalls by providing appropriate visual feedback to the user which conveys the progress of the user's drag-and-drop operation.

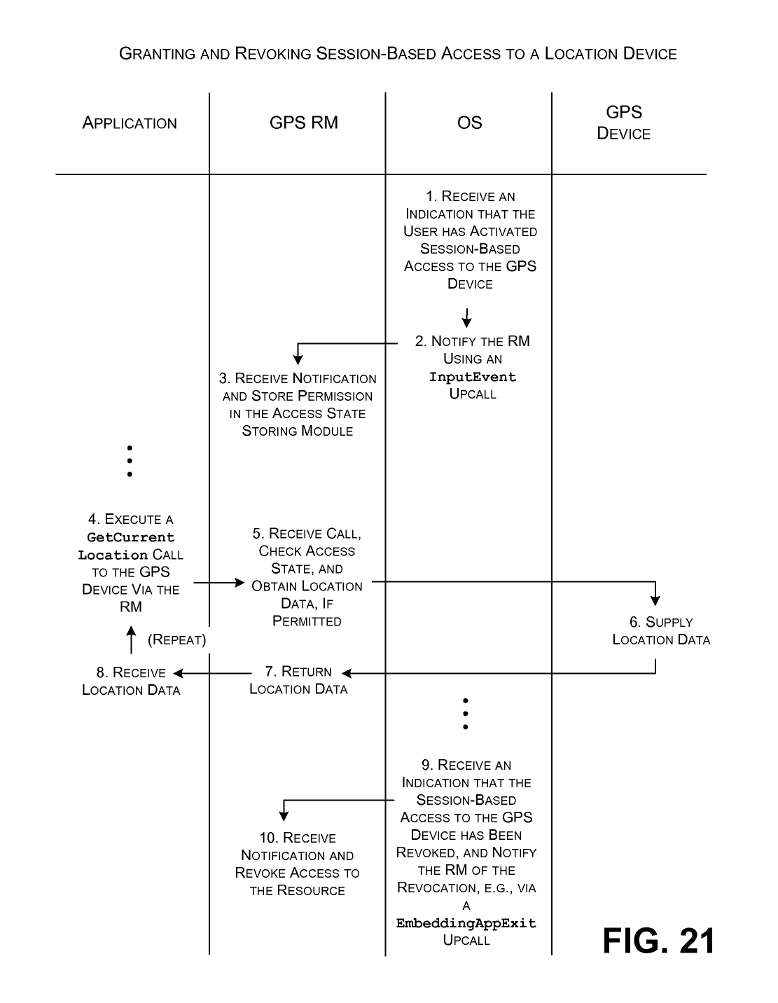

Advancing to FIG. 21, this figure shows a procedure whereby the access system 100 grants session-based access to a location device, such as a GPS device. In operation (1), the operating system 114 receives an indication that the user has activated an IBAM, such as by activating a session-based gadget or performing a PG input sequence. In operation (2), the operating system 114 sends an InputEvent to the appropriate resource monitor. In operation (3), the resource monitor receives the notification and makes an appropriate change of state in the access state storing module 410, e.g., to indicate that the application now has session-based access to the GPS device. In operation (4) (which may occur any time after operation (3)), the application executes a GetCurrentLocation call to request location data from the GPS device, e.g., in response to a user input event, or an application event (which is not triggered by a user input event), etc. In operation (5), the resource monitor receives this call, checks the access state in the access state storing module 410, permits the access to proceed, and mediates access to the GPS device. In operation (6), the GPS device supplies the location data. In operation (7), the resource monitor forwards the location data to the application. In operation (8), the application receives the location data. This process can be repeated one or more times over the course of the application session, e.g., while the application remains running and access privileges remain active. In operation (9), the operating system 114 receives an indication that the access is terminated, e.g., in response to the user closing the application, or in response to the user expressly revoking the rights of the application without closing the application. In the former case, the operating system can send an EmbeddingAppExit upcall to the resource monitor. In operation (10), the resource monitor can revoke the access rights of the application to the GPS device.

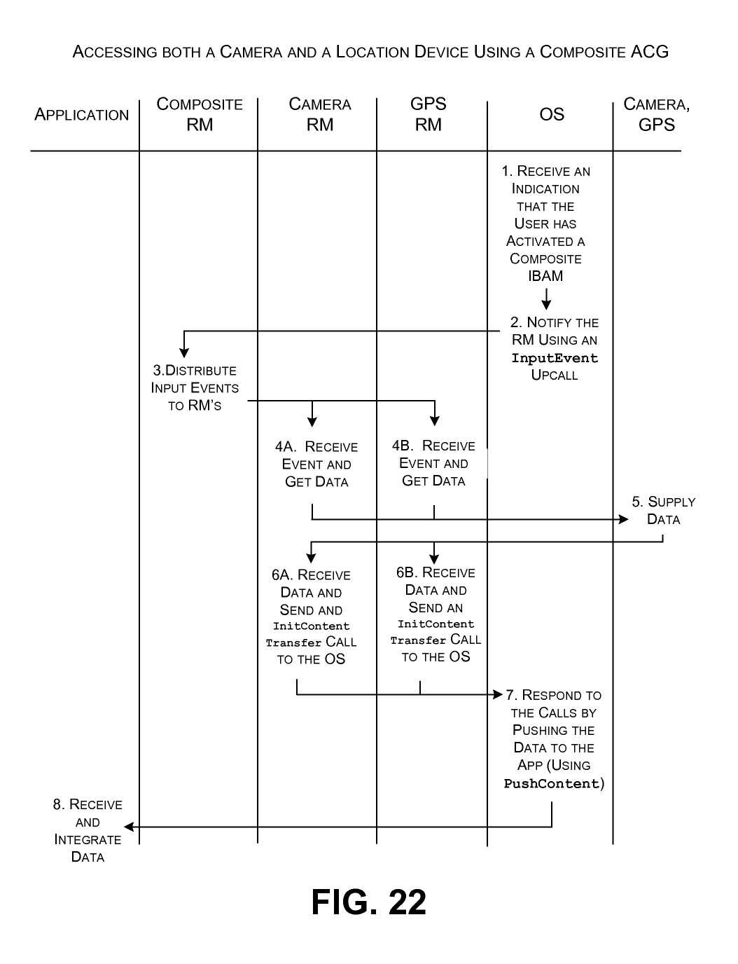

FIG. 22 shows a procedure by which the access system 100 uses a composite IBAM (e.g., a composite gadget) to receive data from both a camera and a GPS device. In operation (1), the operating system 114 receives an indication that the user has activated the composite IBAM, e.g., by activating a composite gadget or performing a composite PG input sequence. In operation (2), the operating system 114 sends an InputEvent upcall to the composite resource monitor. In operation (3), the composite resource monitor receives the InputEvent upcall and, in turn, distributes two input events to the camera resource monitor and the GPS device resource monitor, respectively, using two privileged API calls (exposed only to the composition resource monitor). Those input events can each specify: an ID which identifies the application that will receive access rights; a handle to the running instance of the application; and a transaction ID that allows the application instance to group data returned from the different resource monitors. In operations (4A) and (4B), the camera resource monitor and the GPS resource monitor interacts with the camera and GPS device, respectively, to obtain the picture data and location data. In operation (5), the camera and the GPS device supply the picture data and the GPS data, respectively. In operations (6A) and (6B), the camera resource monitor and the GPS resource monitor initiate the transfer of the collected data to the application by sending out InitContentTransfer calls to the operating system 114. In operation (7), the operating system 114 forwards the transferred data to the application, bypassing the composite resource monitor. But in another implementation, the operating system 114 can transfer the data to the application via the composite resource monitor. In operation (8), the application receives the picture data and the location data.

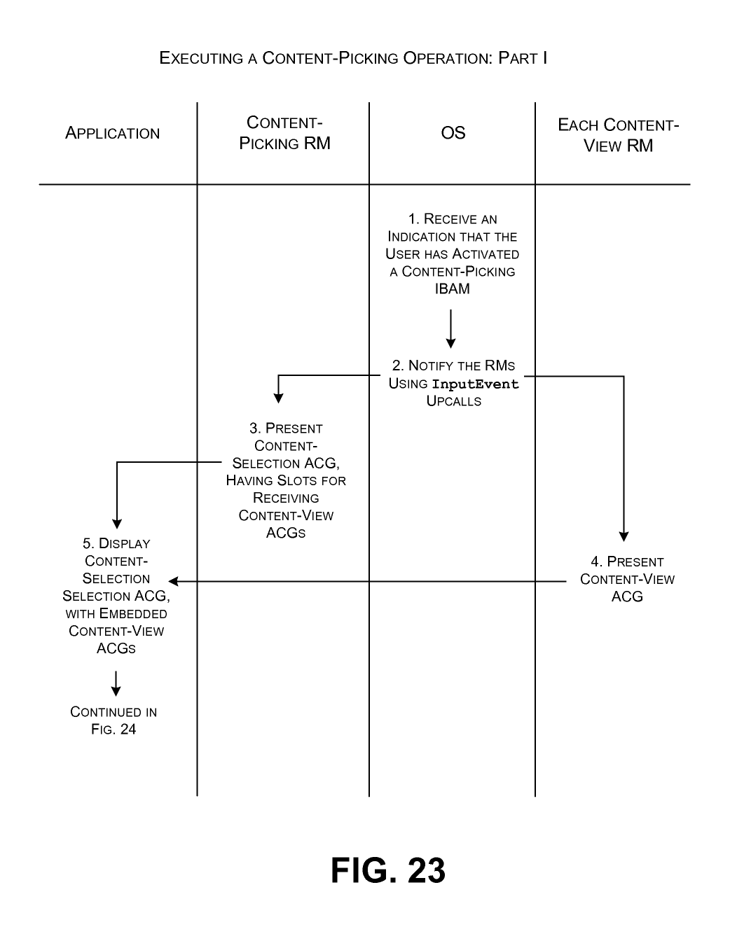

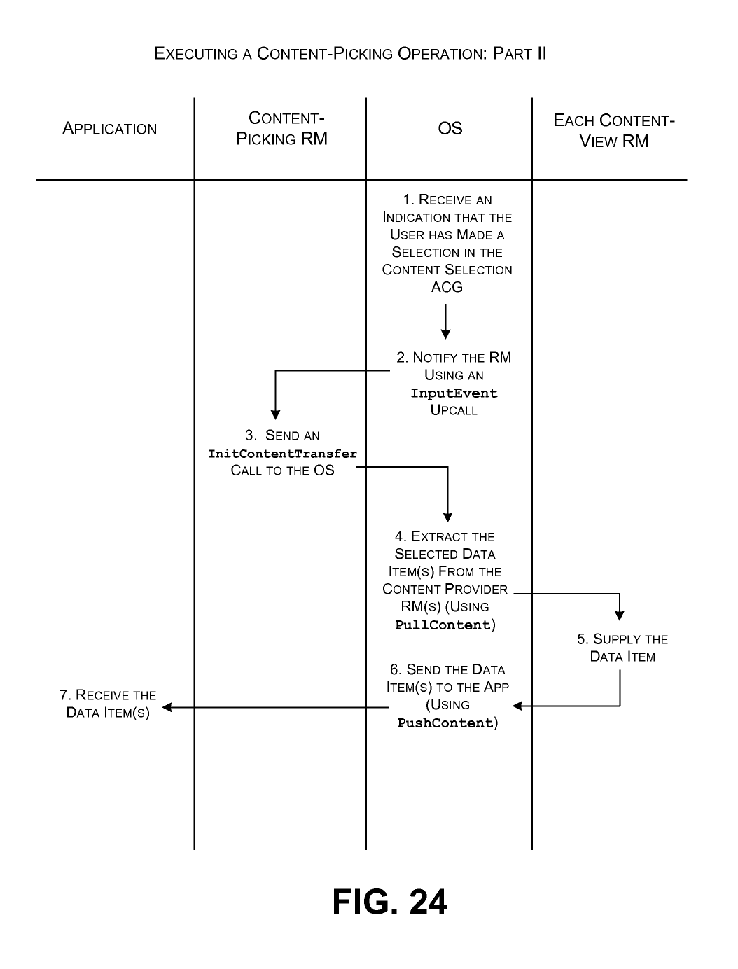

FIGS. 23 and 24 together illustrate a file-picking operation that will be explained in conjunction with FIGS. 15 and 16. In operation (1) of FIG. 23, the operating system 114 receives an indication that the user has activated an IBAM, such as the content-picking gadget 1504 of FIG. 15. In operation (2), the operating system 114 notifies the content-picking RM of this occurrence using an InputEvent. In addition, the operating system 114 can notify each content-view resource monitor of the activation of the file-picking gadget 1504, again using an InputEvent. In operation (3), the content-picking resource monitor displays the content-selection gadget 1604 of FIG. 16, having slots for receiving content-view gadgets. In operation (4), each content-view resource monitor displays a content-view gadget within the content-selection gadget 1604. In operation (5), the application displays the application UI having the populated content-selection gadget 1604 shown in FIG. 16.

Advancing to FIG. 24, now assume that the user activates at least one view item in the content-selection gadget 1604, e.g., by selecting one or more view items and then pressing the OK command button 1616, or by executing a drag-and-drop operation. In operation (1), the operating system 114 receives an indication that the user has activated at least one view item within the content-selection gadget 1604. In operation (2), the operating system 114 sends an InputEvent to the content-picking resource monitor (which provides the content-selection gadget 1604). In operation (3), the content-picking resource monitor receives the call and initiates data transfer using the InitContentTransfer system call. In operation (4), the operating system 114 receives the call and executes a PullContent upcall to obtain the appropriate data item(s) from each appropriate content-provider entity. For example, the extracted data item(s) may correspond to files that the user has selected in the content-selection gadget 1604. In operation (5), each content-view resource monitor supplies the data item(s) which it hosts. In operation (6), the operating system 114 forwards the extracted data items to the application using a PushContent upcall. In operation (7), the application receives the data items and optionally integrates the data items in any manner (e.g., by arranging the data items, etc.). Note that this procedure is carried out without the content-picking resource monitor or application gaining direct access to any item information or data items. That is, the operating system 114 selectively pushes only the data item(s) that the user has selected to the application, but the application is not given general access to any content-provider that supplies the data item(s).

The procedure of FIGS. 23 and 24 can be varied in any way. For example, in another implementation, the operating system 114 can supply the item information to the content-picking resource monitor, instead of, or in addition to, embedding it in isolated content-view gadgets which are not accessible to the content-selection resource monitor. This allows the content-selection resource monitor to sort the view items in the item information, etc. In this implementation, the content-picking resource monitor can obtain the item information by prompting the operating system 114 to perform a PullContent upcall to the appropriate content-view resource monitors, followed by a PushContent upcall to the content-selection resource monitor.

In another variation, a user can directly click on a view item in a content-view gadget to select it, rather than more indirectly selecting the view item and actuating the OK command button 1616. The operating system 114 will then send an InputEvent upcall directly to the content-view resource monitor which implements the content-view gadget. The content-view resource monitor can then obtain and transfer the corresponding data item to the target application, e.g., by sending an InitContentTransfer call to the operating system 114, along with the data item. The operating system 114 sends the data item to the application by using a PushContent upcall. Still other variations of the file-picking operation are possible.

The content-picking operation can also be performed in reverse, e.g., by designating data items to be stored by a content-providing entity. In this case, the pushes and pulls illustrated in FIG. 24 can be performed in reverse order, e.g., to pull information from the application and send it to a content-providing entity for storage. For example, a user can drag a view item into a content-view gadget, causing the corresponding content-provider entity to store a data item associated with the view item.

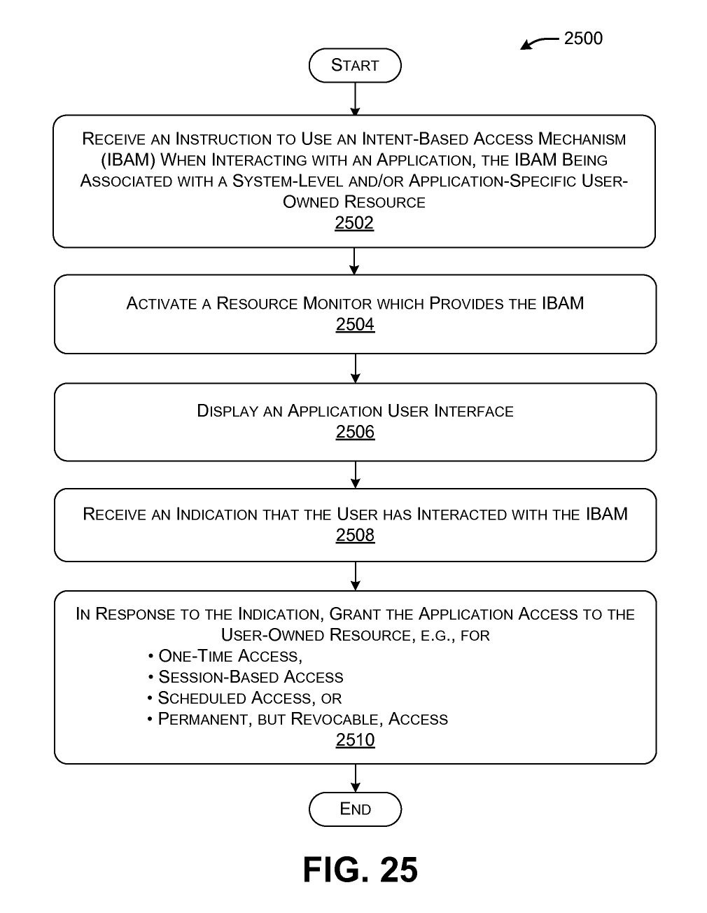

FIG. 25 shows a procedure 2500 which represents a summary of some of the IBAM access actions described above. In block 2502, the access system 100 receives an instruction to use an IBAM when interacting with an application so as to gain access to at least one user-owned resource. The IBAM corresponds to either a gadget or logic for detecting a PG input sequence. The user-owned resource controlled by the IBAM corresponds to either (or both) a system-level resource or an application-specific resource. For the case of gadgets, the access system 100 can perform block 2502 using the EmbedACG system call. In block 2504, the access system 100 activates a resource monitor and an associated process associated with the IBAM. In block 2506, the access system 100 displays an application UI. From the end user's perspective, the application UI appears to incorporate a gadget as an integral part thereof (that is, if the IBAM corresponds to a gadget, and not a PG input sequence).

In block 2508, the access system 100 receives an indication that the user has activated the IBAM, e.g., by either interacting with the gadget or performing the PG input sequence. In block 2510, the access system 100 provides access to one or more user-owned resources associated with the IBAM. The access also has a duration associated with the IBAM. Illustrative durations include a single-transaction access, session-based access, permanent access, scheduled access, etc.

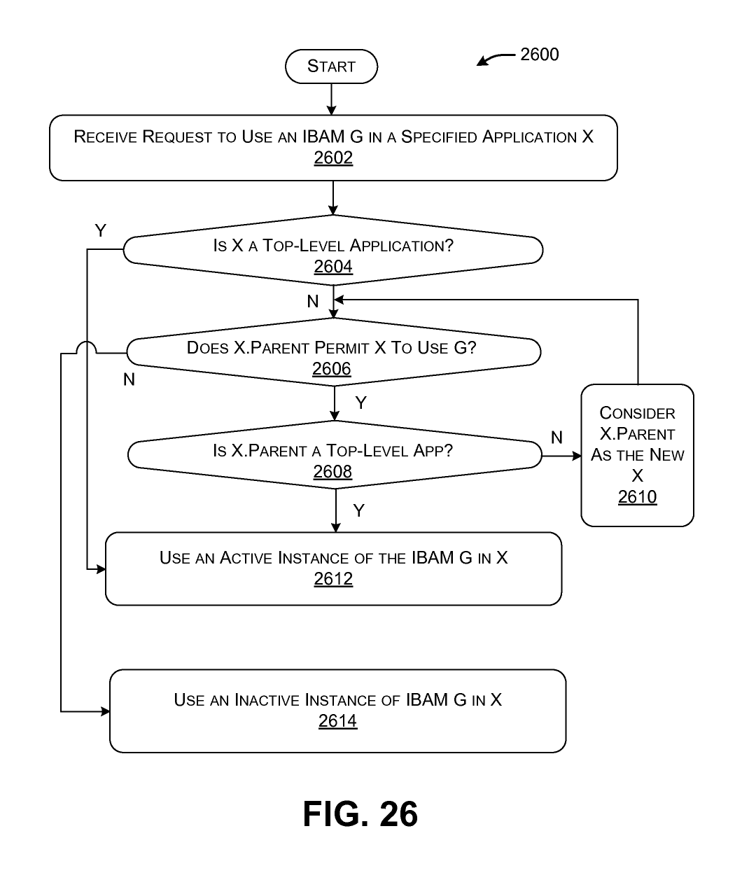

FIG. 26 shows a procedure 2600 by which the operating system 114 determines whether an application X is permitted to use an IBAM G, such as a gadget G or logic for detecting a PG input sequence G. In block 2602, the operating system 114 receives a request to use an IBAM G in the specified application X, e.g., in response to the EmbedACG call (for the case in which the IBAM is a gadget). In block 2604, the operating system 114 determines whether X is a top-level application having a top-level application UI that is not nested in a parent application UI of a parent application. If this is not the case, the operating system 114 advances to block 2606, where it seeks to determine whether the parent application allows the application X to use the IBAM G. It does so by sending the CheckNestedPermission upcall to X.Parent (the parent of X) to determine whether X.Parent allows X to use the IBAM G.

If the answer to block 2606 is “Yes,” then the operating system 114 advances to block 2608, where it determines whether X.Parent is the top-level application in the chain of nested applications. If this is not the case, then, in block 2610, the operating system 114 redefines the current X.Parent as X, and returns to block 2606 to repeat the above-described analysis. In this manner, the operating system 114 successively advances to the outermost top-level application, checking permissions at each step along the way.

Suppose that either block 2604 or block 2608 is answered in the affirmative. Then, in block 2612, the operating system 114 provides an active instance of the IBAM G for use in the application X, such as an active gadget. Alternatively, in block 2614, the operating system 114 provides an inactive instance of the IBAM G in the application X, such as a grayed-out and inoperable instance of the gadget. This behavior is environment-specific; that is, other environments can execute other actions in blocks 2612 and 2614.

In some cases, a child application may possess certain permanent or session-based rights to access a user-owned resource, gained prior to it being embedded in a parent application. If so, in one implementation, the child application does not lose those rights when it is embedded in a parent application, even if the parent application does not allow its children to embed gadgets.

C. Representative Computing Functionality

FIG. 27 sets forth illustrative computing functionality 2700 that can be used to implement any aspect of the functions described above. For example, the computing functionality 2700 can be used to implement any aspect of the access system 100 of FIG. 1, e.g., as implemented in the embodiment of FIG. 8 or FIG. 9, or in some other embodiment. In one case, the computing functionality 2700 may correspond to any type of computing device that includes one or more processing devices. In all cases, the electrical data computing functionality 2700 represents one or more physical and tangible processing mechanisms.

The computing functionality 2700 can include volatile and non-volatile memory, such as RAM 2702 and ROM 2704, as well as one or more processing devices 2706 (e.g., one or more CPUs, and/or one or more GPUs, etc.). The computing functionality 2700 also optionally includes various media devices 2708, such as a hard disk module, an optical disk module, and so forth. The computing functionality 2700 can perform various operations identified above when the processing device(s) 2706 executes instructions that are maintained by memory (e.g., RAM 2702, ROM 2704, or elsewhere).

More generally, instructions and other information can be stored on any computer readable medium 2710, including, but not limited to, static memory storage devices, magnetic storage devices, optical storage devices, and so on. The term computer readable medium also encompasses plural storage devices. In all cases, the computer readable medium 2710 represents some form of physical and tangible entity.

The computing functionality 2700 also includes an input/output module 2712 for receiving various inputs (via input modules 2714), and for providing various outputs (via output modules). One particular output mechanism may include a presentation module 2716 and an associated graphical user interface (GUI) 2718. The computing functionality 2700 can also include one or more network interfaces 2720 for exchanging data with other devices via one or more communication conduits 2722. One or more communication buses 2724 communicatively couple the above-described components together.

The communication conduit(s) 2722 can be implemented in any manner, e.g., by a local area network, a wide area network (e.g., the Internet), etc., or any combination thereof. The communication conduit(s) 2722 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by computing functionality, for granting an application access to a user-owned resource, comprising:
receiving an instruction to provide an intent-based access mechanism for use in interacting with the application, the intent-based access mechanism being associated with the user-owned resource;
activating a resource monitor which is associated with the intent-based access mechanism, the resource monitor mediating access the user-owned resource;
displaying an application user interface on a display mechanism of a user device;
receiving an indication that the user has invoked the intent-based access mechanism; and
in response to receiving the indication, granting the application access to the user-owned resource, based on knowledge that the intent-based access mechanism has received authentic user input,
the application otherwise lacking rights to access user-owned resources in accordance with a least-privilege access paradigm,
the intent-based access mechanism corresponding to either:
(a) a gadget; or
(b) logic for detecting a permission-granting input sequence, the permission-granting input sequence being made up of one or more triggering input events produced by the user using one or more input devices,
the intent-based access mechanism further corresponding to either:
(a) a system-level intent-based access mechanism which provides access to a system-level resource; or
(b) an application-specific intent-based mechanism provided by a hosting application which provides access to an application-specific resource.

2. The method of claim 1, wherein the system-level resource comprises at least one of:
a physical device for capturing data;
a physical device for receiving data;
a virtual software-implemented resource; and
a setting.

3. The method of claim 1, wherein the application-specific resource comprises data or a service provided by the hosting application via an interface, and wherein the hosting application provides the intent-based access mechanism to ensure authentic interaction by the user with the interface.

4. The method of claim 1, wherein the intent-based access mechanism is a composite intent-based access mechanism and the resource monitor is a composite resource monitor, and wherein the composite resource monitor mediates access to two or more user-owned resources via two or more respective component resource monitors.

5. The method of claim 4, wherein the composite resource monitor sends an input event to said two or more component resource monitors when the user interacts with the composite intent-based access mechanism.

6. The method of claim 1, wherein the resource monitor provides access to the user-owned resource for a duration of access corresponding to one of:
a single-transaction access;
a session-based access; and
a permanent, but revocable, access.

7. The method of claim 1, wherein the resource monitor provides access to the user-owned resource based on at least one specified scheduling condition, wherein the resource monitor receives said at least one scheduling condition from the user via a scheduled intent-based access mechanism.

8. The method of claim 1, further comprising responding to the instruction to provide the intent-based access mechanism by determining whether the application permits the intent-based access mechanism to be used by the application.

9. The method of claim 8, wherein said determining comprises:
determining whether the application corresponds to a top-level application having a top-level application user interface which is not nested in a parent application user interface provided by a parent application; and
if the application corresponds to a top-level application, then permitting the application to use the intent-based access mechanism.

10. The method of claim 9, wherein, if the application does not correspond to a top-level application, then the application corresponds to a child application having a child application user interface that is nested in the parent application user interface, and the method further comprising:
checking whether the parent application permits the intent-based access mechanism to be used by the child application,
if the parent application permits the intent-based access mechanism to be used by the child application, permitting the child application to use the intent-based access mechanism if the parent application is a top-level application, and
if the parent application is not a top-level application, considering the parent application as a new child application and repeating said checking with respect to the parent of the new child application.

11. The method of claim 1, wherein the intent-based access mechanism comprises a content-selection gadget, and wherein said granting comprises:
providing the content-selection gadget in response to activation of a content-picking gadget, the content-selection gadget displaying item information regarding data items hosted by one or more content-provider entities;
receiving an indication that the user has selected at least one view item specified by the item information within the content-selection gadget; and
granting the application access to at least one data item, said at least one data item corresponding, respectively, to said at least one view item that has been selected.

12. The method of claim 11, wherein the content-selection gadget embeds at least one content-view gadget that is hosted by a corresponding content-provider entity using a corresponding content-view resource monitor, the content-view gadget conveying item information regarding data items that are provided by the content-provider entity.

13. The method of claim 12, wherein the application receives said at least one data item without exposing said at least one data item to a resource monitor which provides the content-selection gadget.

14. The method of claim 12, wherein the content-view resource monitor is isolated from a resource monitor which provides the content-selection gadget.

15. A computer readable storage medium for storing computer readable instructions, the computer readable instructions implementing a method when executed by one or more processing devices, the method comprising:
presenting a content-selection gadget provided by a content-selection resource monitor,
the content-selection gadget incorporating at least one content-view gadget that is hosted by a corresponding content-provider entity using a corresponding content-view resource monitor, the content-view gadget conveying item information regarding data items that are provided by the content-provider entity;
receiving an indication that the user has selected at least one view item identified by the item information in the content-view gadget;
in response to receiving the indication, obtaining at least one data item corresponding to said at least one view item that has been selected, from the content-provider entity; and
providing said at least one data item to an application without exposing the said at least one data item to the content-selection resource monitor.

16. The computer readable storage medium of claim 15, wherein the item information provided by the content-view gadget identifies one or more files that are maintained by the content-provider entity.

17. The computer readable storage medium of claim 15, wherein the item information provided by the content-view gadget identifies one or more user contacts that are maintained by the content-provider entity.

18. The computer readable storage medium of claim 15, wherein the item information provided by the content-view gadget identifies search results from the content-provider entity, the search results matching a specified search term.

19. An access system, implemented by computing functionality, for granting an application access to a user-owned resource, comprising:
logic configured to receive an instruction to activate an intent-based access mechanism for receiving authentic user input in a context of a specified application; and
logic configured to inquire whether the specified application permits the intent-based access mechanism to be used in the context of the specified application,
said logic configured to inquire receiving an affirmative response if:
the specified application is a top-level application having a top-level application user interface that is not nested in a chain of one or more ancestor application user interfaces, provided by a corresponding chain of one or more ancestor applications; or
the specified application is a child application that has a child application user interface that is nested in the chain of one or more application user interfaces, and each ancestor application in the chain of one or more ancestor applications authorizes an intent-based access mechanism to be used in the context of its respective child application.

20. The access system of claim 19, wherein the intent-based access mechanism for receiving authentic user input comprises one of:
a gadget; or
logic for detecting a permission-granting input sequence that is made up of one or more triggering input events produced by the user using one or more input devices.
